SEQUENCE LISTING (2 sequences)

SEQ ID NO: 1 - DNA, 20 bp, Unknown
  PCR primer
ggtgtgatgggatggataaa

SEQ ID NO: 2 - DNA, 20 bp, unknown
  PCR primer
ccctgcatttcttttgtttg

(19) United States
(12) Patent Application Publication
(10) Pub. No.: US 2024/0001363 A1
(43) Pub. Date: Jan. 4, 2024

(54) SYSTEM AND METHOD FOR SORTING OF PARTICLES

(71) Applicant: SAMPLIX APS, Herlev (DK)

(72) Inventors: Marie JUST MIKKELSEN, Brønshøj (DK); Thomas KVIST, Roskilde (DK); Solène CHERRÉ, Mileparken (DK)

(73) Assignee: SAMPLIX APS, Herlev (DK)

(21) Appl. No.: 18/252,108

(22) PCT Filed: Nov. 30, 2021
(86) PCT No.: PCT/EP2021/083518

§ 371 Date: May 8, 2023

(30) Foreign Application Priority Data
Dec. 1, 2020 (DK) PA202001365
Sep. 28, 2021 (DK) PA202100916

(51) Int. Cl. B01L 3/00

(52) U.S. Cl. CPC B01L 3/502761; B01L 3/502715; B01L 3/50273; B01L 3/502784; B01L 2200/0652; B01L 2200/0673; B01L 2300/0864; B01L 2400/0487

(57) ABSTRACT

The present invention relates to a system for sorting particles by characteristics that can be optically detected. The system comprises a microfluidic device that is capable of sorting the particles, and an instrument driving the fluids through the microfluidic device and invoking the sorting events in response to the optical signals emitted by the particles. The present invention also relates to a method for enrichment or isolation of a nucleotide fragment comprising a known nucleotide sequence element and to a kit comprising a plurality of microfluidic devices and a plurality of fluids configured for use with the microfluidic device for sorting of emulsion droplets.

### TECHNICAL FIELD

The present invention relates to a system for sorting particles (e.g., droplets) by characteristics that can be optically detected. The system comprises a microfluidic device that is capable of sorting the particles, and an instrument driving the fluids through the microfluidic device and invoking the sorting events in response to the optical signals emitted by the particles.

The invention also relates to a method for enrichment or isolation of a nucleotide fragment comprising a known nucleotide sequence element.

Furthermore, the present invention relates to a kit comprising a plurality of microfluidic devices and a plurality of fluids configured for use with the microfluidic device for sorting of emulsion droplets.

### BACKGROUND

European patent, EP 3 314 012 B1, describes a highly effective in-vitro method for enriching for one or more target DNA molecule from a sample of mixed DNA molecules. The method depends on the separation of the DNA sample into numerous particles (droplets) and the physical selection of the droplets based on the optical signals emitted by the droplets. The physical selection may be obtained by use of a manually operated microfluidic chip or the use of a fluorescence activated cell sorter (FACS). In either case the selection is time consuming and results in relatively few signal-positive droplets.

To improve the yield of the enriching the inventors set out to develop an automated system which can scan and select a very large number of particles in a relatively short time, while avoiding the loss of sample particles inherent to FACS-sorting.

It has previously been reported that various types of particles (cells, droplets, particles entrained in droplets, etc.) may be sorted by various types of microfluidic devices. Exemplary devices or methods are described in EP 3 302 801; U.S. Pat. Nos. 10,697,007; 8,691,164 and 8,623,295.

However, none of these seem to provide the sorting of a very large number of particles in a relatively short time, while avoiding the use of large amounts of buffer required for the necessary spacing of the particles to obtain an effective sorting.

### SUMMARY OF THE INVENTION

Instrumental to reach to the solution is to realise that the population of particles (droplets) inherent to the method of EP 3 314 012 B1, is characterised by very few positive particles amongst very many negative particles.

Also, other populations of particles, e.g., fetal cells in a blood sample from a pregnant woman, are characterised by very few positive particles amongst very many negative particles.

Having realised this, the inventors of the present invention have solved the problem of sorting out relatively few fluorescent-positive particles from a large number of negative particles by a system for sorting of particles in a liquid medium. The system comprises a microfluidic device (cartridge) which comprises at least one microfluidic sorting-unit, at least one detection zone and an instrument which controls the flow of fluids through the cartridge.

The present invention is particularly useful for the sorting of a sample comprising positive and negative particles wherein the ratio (or expected ratio) of positive particles to negative particles is in the range from about 1:10 mio (10⁶) to about 1:100, particularly in the range of about 1:1 mio to about 1:1000

FIG. 11 illustrates a system of the invention.

In one embodiment, the system comprises a plurality (e.g., 8) of individual sorting-units and is designed to change the flow rate through the sorting-unit in response to detecting a positive particle in the sample feeding conduit upstream of the sorting-junction allowing over 50 mill (50×10⁶) particles to be sorted in less than 2 hours, while minimizing the loss of particles during the sorting and minimizing use of buffer.

Thus, according to a first aspect of the present invention, there is provided a system for sorting various types of particles including droplets in a liquid medium. The system comprises a cartridge comprising at least one microfluidic sorting-unit wherein a unit comprises (i) at least one sample feeding conduit for feeding a sample fluid to a sorting-junction wherein the sample fluid comprises a mixture of positive and negative particles to be sorted [1], (ii) at least one microfluidic sorted positive particles conduit for removing a fluid comprising positive particles from the sorting-junction [4], and (iii) at least one microfluidic waste conduit for removing a waste fluid comprising negative particles from the sorting-junction [5], said unit characterized in that the at least three microfluidic conduits (i), (ii) and (iii) meet at the sorting-junction,
said cartridge further comprising at least one detection zone for detecting a positive particle in the sample feeding conduit (i) upstream the sorting-junction, and
an instrument which controls the flow of fluids through the at least one microfluidic sorting-unit and which regulates the flow rate of particles in the sample feeding conduit in response to detecting a positive particle in the feeding conduit upstream of the sorting-junction.

A second aspect of the invention is a separate microfabricated sorting device—a cartridge—which fits into the instrument, but which is removable therefrom.

The cartridge comprises at least one microfluidic sorting-unit, which is an integral part of a sorting lane [15]. Typically, the cartridge comprises two or more sorting lanes each of which comprises wells/containers of a size to contain all push-fluid, spacer-fluid, sample of suspended particles, waste particles, and sorted positive particles required for the sorting.

According to a third aspect of the present invention, there is provided an instrument which can control the flow of fluids through the at least one microfluidic sorting-unit and which regulates the flow rate of particles in the sample feeding conduit in response to detecting a positive particle in the feeding conduit upstream of the sorting-junction and comprises an optical system that forms 2 linear (or oblong) detection zones, an upstream and a downstream detection zone.

According to a fourth aspect of the present invention, there is provided a method for sorting particles comprising using the system. The method comprising the steps of:
i. providing a sample fluid comprising particles,
ii. providing a microfluidic cartridge according to the second aspect comprising a supply well or container comprising a volume of push-fluid, a supply well or container comprising a volume of spacer-fluid and a supply well or container comprising a volume of the particle sample fluid,
iii. inserting the cartridge into the instrument,
iv. starting the sorting on the instrument, and
v. after the sorting is complete, transferring the sorted positive particles into a suitable container.

According to a fifth aspect of the present invention, there is provided a method for in-vitro enriching for one or more target nucleic acid molecules from a sample of mixed nucleic acid molecules comprising the steps of:
i. providing a liquid sample of mixed nucleic molecules comprising at least one or more specific target nucleic acid molecule and at least one reagent for a specific detection of at least one of said target nucleic acid molecules,
ii. forming an emulsion comprising a plurality of double-emulsion liquid droplets each comprising mixed nucleic acid molecules from said liquid sample,
iii. incubating the emulsion liquid droplets to obtain a specific detectable reaction in droplets containing at least one specific target nucleic acid molecule,
iv. loading the reacted droplets into the system for sorting droplets according to any of the previous aspects,
v. sorting the microdroplets by use of the system,
vi. collecting the sorted droplets in a suitable container, coalescing the sorted droplets, and
vii. subjecting the coalesced selected droplets from step vi to a general amplification procedure.

According to a sixth aspect of the present invention, there is provided a kit for sorting droplets and/or in-vitro enriching for one or more target DNA molecules, which comprises: a) at least one cartridge according to second aspect; b) at least one gasket for the at least one cartridge to an instrument of the system for sorting of particles, particularly the system according first aspect, to obtain the necessary tight connection between the openings of the cartridge and the corresponding openings of the instrument; and c) one or more vials of push buffer and space buffer in an amount sufficient to perform the number of sortings provided for by the one or more cartridge of the kit.

The present invention relates to different aspects including the devices and methods described above and in the following. Each aspect may yield one or more of the benefits and advantages described in connection with one or more of the other aspects. Each aspect may have one or more embodiments with all or just some of the features corresponding to the embodiments described in connection with one or more of the other aspects and/or disclosed in the appended claims.

Other systems, methods and features of the present invention will be or will become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The drawings illustrate the design and utility of embodiments. These drawings are not necessarily drawn to scale. The drawings may only depict typical embodiments and may therefore not be considered limiting of the scope of the invention.

FIG. 1: Schematic illustration of a sorting-junction of the invention. Arrows indicate direction of fluid-flow.

FIG. 2: Schematic illustration of one embodiment of the central part of a sorting-unit of the invention. Arrows indicate direction of fluid-flow. Particles are indicated by black spheres. The dashed box indicates the downstream detection zone.

FIG. 3: Schematic illustration of one embodiment of a pair of sorting lanes and the associated in-let and out-let-orifices/ports. The two detection zones are also indicated.

FIG. 4 A: Close up of an embodiment of a pair of feeding conduits upstream of the sorting-junction showing the short and the long detection loop used to differentiate between the 2 lanes. Detection zone 1 is also indicated. FIGS. 4 B and C illustrate the time interval between the first and the second detection of a positive particle (time delta) passing through the long and the short lane respectively. See also FIG. 16.

FIG. 5: Close up illustrating one preferred embodiment of a pair of sorting-units showing the second detection zone. The dashed box indicates the downstream detection zone. The use of e.g., 1 and 1′ is used to indicates similar structures, here the sample feeding conduit, of two separate sorting-units of a pair.

FIG. 6: An embodiment of 4 pairs of sorting lanes residing in a chip. FIG. 6A schematically illustrates an isometric view of the microfluidic section. FIG. 6b shows a top view of the microfluidic section.

FIG. 7: An embodiment of a microfluidic cartridge according to the present invention. FIG. 7a schematically illustrates an isometric view of the cartridge.

FIG. 7b is a top view of the cartridge. FIG. 7c show a cross-sectional side view along the A-A of FIG. 7b.

FIG. 8: Overlay of brightfield and fluorescent images after droplet production before sorting. A small fraction of the droplets contained a fluorescent bead. In this view only one droplet contained a bead, marked with an arrow. An enlargement of this droplet is shown as an insert.

FIG. 9: Overlay of brightfield and fluorescent microscope images of sorted droplets. Arrows point to double emulsion droplets with beads. Broken line arrows point to double emulsion droplets without beads.

FIG. 10: Overview of the system and method. Arrows indicate direction of fluid-flow in conduits.

FIG. 11: Schematic representation illustrating that a preferred embodiment of the instrument can accept both single emulsion and double emulsion droplet-forming cartridges as well as particle sorting-cartridges according to the present invention.

FIG. 12: Schematic illustration of main components of the instrument.

FIG. 13: Schematic illustration of the pressure regulating components of one embodiment of the instrument.

FIG. 14 shows a series of close-up pictures of the sorting-junction during sorting. Left side of figure are micro-graphs, right side black and white interpretations of the micro-graphs.

FIG. 14a illustrates the situation before the gate opens.

FIG. 14b illustrates the situation when the gate opens.

FIG. 14c illustrates a droplet being sorted.

FIG. 14d illustrates the situation when the gate closes again.

Arrows indicate direction of fluid-flow in conduits. Note, meta-cresol purple was added to the droplet sample buffer containing the double emulsion droplets to visualize the operation of the sort function in a bright field microscope.

Timestamps: FIG. 14a 0.780 s; FIG. 14b 0.868 s; FIG. 14c 1.111 s; and 14d 1.404 s.

FIG. 15: Detection of positive droplets using a silicon photomultiplier. Graph shows voltage-readout in mV from the photomultiplier (PMT) as a function of time (s).

FIG. 16 shows the measured delay times from the two lanes of a pair of sorting lanes, with different loop length. The vertical axis shows the time interval between dual peaks in ms. The two boxes indicate the 75% confidence interval.

FIG. 17 illustrates the situation when no positive particles are observed at the upstream detection zone. In this situation there is no or only limited influx of spacer-fluid, and the fluid speed in the sample feeding conduit is high.

FIG. 17a is a micro-graph of the sorting-unit during this phase. FIG. 17b is a close-up of the sorting-junction, and FIG. 17c is a B/W interpretation of the sorting-junction.

FIG. 18 shows double emulsion droplets produced using the instrument of the invention and a double-emulsion generating cartridge. FIG. 18a shows micro-graphs from 6 individual preparations. FIG. 18b is an enlargement of the section indicated in FIG. 18a.

FIG. 19 is an example of single emulsion droplets produced using the instrument of the invention and a single-emulsion generating cartridge.

FIG. 20 compares a sorting-junction with push buffer inlet to a junction without push buffer inlet.

FIG. 20 panel A-D illustrate a sorting-junction with a push buffer inlet.

FIG. 20 panel E-H illustrate a sorting-junction without a push buffer inlet.

FIG. 20 panel A and E illustrate the situation before sorting.

FIG. 20 panel B and F illustrate the situation during sorting.

FIG. 20 panel C and G illustrate the situation right after sorting (timepoint 1 after sorting).

FIG. 20 panel D and H illustrate the situation later after sorting (timepoint 2 after sorting).

P1 indicates the pressure in the push-fluid conduit.

P2 indicates the pressure in the sample feeding conduit.

P3 indicates the pressure in the negative particle conduit (waste conduit).

P4 indicates the pressure in the positive particle conduit (sorted droplets conduit).

Arrows indicate direction of fluid-flow.

The shaded tone illustrates the situation when e.g., meta-cresol purple was added the droplet sample buffer containing the double emulsion droplets in order to visualize the operation of the sorting function in a brightfield microscope.

FIG. 21 shows the actual sorting of a positive droplet. Panel A, A′ and A″ show the situation before sorting has occurred. Panel B, B′ and B″ show the situation right after sorting of a positive particle [7] has occurred, and Panel C, C′ and C″ show the situation some 6 ms after the sorting.

Panel A, B and C show the actual micro photos. Black arrows point to positive particles, white arrows point to negative particles. Panel A′, B′ and C′ show an enhancement of the micro photos, and Panel A″, B″ and C″ show a line drawing of panel A, B and C.

FIG. 22: Effect of spacer-fluid and flow-speed of the fluids. Left side of figure are micro-graphs, right side are B/W interpretations of the micro-graphs. Arrows indicate direction of fluid-flow.

Panel A is time-stamped 1,135 s; panel B is time-stamped 2,003 s; panel C is time-stamped 4,655 s and panel D is time-stamped 4,770 s.

FIG. 22 panel A illustrates the situation before a positive particle has been detected at the upstream detection zone. In this situation a relatively high pressure is applied onto the particle sample inlet, and no or only a very limited pressure is applied onto the spacer-fluid inlet. The result is a high fluid speed in the sample feeding conduit, and only a very limited influx of spacer-fluid at the spacer-fluid junction.

FIG. 22 panel B illustrates the situation when the pressures has been switched to a moderate pressure onto the particle sample inlet, and a relatively high pressure is put onto the spacer-fluid inlet. The result is a low fluid speed in the sample feeding conduit, and a significant influx of spacer-fluid at the spacer-fluid junction.

FIG. 22 panel C illustrates the situation immediately before the pressures on the particle sample inlet and the spacer-fluid inlet switch to the situation shown in i FIG. 22 panel D.

FIG. 22 panel D illustrates the situation immediately after the pressures on the particle sample inlet and the spacer-fluid inlet have switched to a relatively high pressure on the particle sample inlet and a relatively low pressure on the spacer-fluid inlet thereby restoring the situation of a high fluid speed in the sample feeding conduit, and only a limited influx of spacer-fluid at the spacer-fluid junction shown in panel A.

FIG. 23: Sectioned view showing part of the manifold and cartridge support tray of a preferred embodiment of the instrument.

FIG. 24: A perspective view of the manifold and the cartridge support tray with a cartridge including a gasket inserted of a preferred embodiment of the instrument.

FIG. 25: Sectioned view showing part of the manifold and cartridge support tray with an inserted cartridge. The manifold is in a raised configuration that permits the cassette to be loaded into and removed from the instrument.

FIG. 26: Is a plan view of a preferred embodiment of the instrument showing part of the manifold and cartridge support tray with an inserted cartridge. The manifold is in a raised configuration.

FIG. 27: Diagram of one embodiment of the pneumatic system. Note the directional three-way valves of the system are not shown.

FIG. 28: Schematic view (piping and instrumentation diagram) of the pneumatic system shown in FIG. 27.

FIG. 29: Flow diagram illustrating the automatic alignment procedure.

FIG. 30: Sketch of the optical system comprised in the optical head.

FIG. 31: Illustration of the concept of loop time. Loop time is the time it takes a droplet to get from point a to point b. Accordingly the loop time in situation A is a relative long loop time, whereas in situation B the loop time is relative short. Arrows indicate direction of flow.

FIG. 32: Cross sectional view of one embodiment of the instrument showing the manifold, the cartridge support tray and the optical head in an open (unclamped) position.

FIG. 33: Cross sectional view of an embodiment of the manifold and the cartridge support tray with a single emulsion cartridge including a gasket inserted. The assembly is in an open (unclamped) position.

FIG. 34: A perspective view of an embodiment of the optical head alignment mechanism showing the 3 actuators. Mechanism seen from below.

FIG. 35: A 3D view of an exemplary system according to the invention that includes an instrument which drive the fluids through a microfluidic device inserted into the instrument. Panel A show the instrument in a closed configuration, panel B show the instrument in an open configuration.

FIG. 36: One embodiment of the manifold and the cartridge support tray with a cartridge including a gasket inserted in the closed position where the cartridge is clamped to the manifold.

Panel A is a perspective view. Panel B is a sectioned view.

FIG. 37: An example of signals registered by the instrument during a sorting cycle.

Panels A and B show a 1 s recording, whereas Panels C and D show a 20 s recording of the signal. The latter show four successful sorting cycles.

Panel A and C show the valve stages of the instrument as a function of time, in milli-seconds, note the different time-scales.

Each valve can be in 2 stages (low or high pressure). The curve marked as “I.” shows the stages of the valves directing the pressure in the push buffer [608], the Spacer buffer [612], and the Droplet buffer [613] conduits.

The curve marked as “II.” show the stages of the valves directing the pressure in the Sort conduit [617].

The curve marked as “III.” show the stages of the valves directing the pressure in the Waste conduit [618].

Panels B and D show signals detected by the instrument as a function of the valve-stages and time, note the two different time-scales of B and D.

“DZ1” indicate the signal detected by the detector at the upstream detection zone 1 [12/801]. “DZ2” indicate the signal detected by the detector at the downstream detection zone 2 [13/802].

### DEFINITIONS

Prior to a discussion of the detailed embodiments of the invention a definition of specific terms related to the main aspects of the invention is provided.

The term “amplification” as used herein may refer to a reaction that form multiple copies of at least one segment of a template molecule.

Herein, the terms “oil”, “emulsion oil” and “carrier fluid” may be used synonymously in the case of single emulsion droplets. In case of double emulsion droplets, the carrier fluid is typically an aqueous fluid.

“Feeding conduit” is the conduit connecting the sample inlet well or container with the sorting-junction (i.e., the conduit extending from the sample inlet well to the sorting-junction).

“dMDA” refers to the multiple displacement amplification (MDA) technique, Blanco et al (1989) J. Biol. Chem. 264: 8935-40; Zanoli et al (2013) Biosensors 3, 18-43, performed in droplets.

The term “droplet” as used herein refers to a small volume of liquid, typically in a spherical shape, surrounded by an immiscible fluid such as a continuous phase of emulsion. Throughout the present disclosure, the terms “droplet” and “micro-droplet” are used synonymously. It refers to droplets forming an emulsion of droplets each of which is comparable with the dimensions of a microfluidic device.

A droplet may be spherical or of other shapes depending on the external environment.

Typically, the droplet has a volume of 1 μL or less, preferably of 1 nL or less, e.g., 0.0001 nL to 1 nL. Single emulsion droplets are usually larger than double emulsion droplets.

The term “double emulsion droplet” refers to a water-in-oil-in-water droplet (also named w/o/w droplet) and consists of an aqueous droplet inside an oil droplet, i.e., an aqueous core and an oil shell, surrounded by an aqueous carrier fluid.

Preferably, the double emulsion is a monodispersed emulsion, i.e., an emulsion comprising droplets of approximately the same volume. Typically, the w/o/w droplet has a volume of less than 1000 pL, preferably of less than 100 pL. Preferably, a w/o/w droplet has a volume ranging from 0.1 pL to 50 pL, more preferably from 0.25 pL to 25 pL, even more preferably from 0.5 pL to 10 pL, and in particular from 1 pL to 5 pL.

For some applications, such as when mammalian cells are encapsulated within the droplets, the w/o/w droplet may have a volume of between 3 pL and 500 pL. Preferably, a w/o/w droplet has a volume ranging from 5 pL to 200 pL, more preferably from 30 pL to 150 pL.

“The term “single emulsion droplet” refers to an isolated portion of an aqueous phase that is completely surrounded by an oil phase.

Preferably, the water-in-oil emulsion is a monodispersed emulsion, i.e, an emulsion comprising droplets of the same volume. Techniques for producing such a homogenous distribution of diameters are well-known by the skilled person (see for example WO 2004/091763).

The term “downstream” refers to components or modules in the direction of the flow of fluids from a given reference point in a microfluidic system, in the present context the reference point is the sorting-junction.

The term “upstream” refers to components or modules in the direction opposite to the flow of fluids from a given reference point in a microfluidic system, in the present context the reference point can e.g., be the spacer-fluid junction or the sorting-junction.

“Fluorocarbon oil”, perfluorocarbons or PFCs, are organofluorine oils typically with a density higher than water. Examples of a useable oils are the Fluorinert™ FC-40, Sigma-Aldrich, St. Louis, MO, USA; Krytox™, Chemours, Wilmington, DE, USA; and Novec™ Oil, 3M Co., Maplewood, MN, USA.

The term “Identifying characteristics” as used herein refers to any characteristic of an entity that can be used to identify the entity. It may be an optically detectable signal (e.g., a fluorescent signal) or any other signal (e.g., a magnetic or a radioactive signal).

The term “microfabricated” is used to describe a method of fabricating which results in a device, which comprises one or more fluid conduits or features being in the microscale.

Throughout the text “microfabricated device”, “microfluidic device” and “cartridge” are used synonymously. It may refer to the part of the system which comprises a microfluidic network that are able to sort a suspension of particles when provided with suitable fluids and subjected to conditions which facilitates flow through the microfluidic network. It may also refer to a droplet-forming device which comprises a microfluidic network and which fit into the instrument. Typically such devices (cartridges) are made of two or more parts made from one or more types of polymers such as PMMA (Poly(methyl methacrylate)), Polycarbonate, Polydimethylsiloxane (PDMS), COC Cyclic Olefin Copolymer (COC) e.g. including also TOPAS, COP Cyclo-olefin polymers (COP) including ZEONOR®, Polystyrene (PS), polyethylene, polypropylene, or negative photoresist SU-8. In addition, the cartridge may contain parts made of materials including glass, silicon, or other materials providing hydrophilic properties.

The term “microfluidic” implies that at least a part of the respective device/unit comprises one or more fluid conduits being in the microscale, such as having at least one dimension, such as width and/or height, being smaller than 1 mm and/or a cross-sectional area smaller than 1 mm². The smallest dimension, such as a height or a width, of at least one part of the fluid conduit network, such as a conduit, an opening, or a junction, may be less than 500 μm, such as less than 200 μm, for example less than 20 μm.

The “collection orifice” is the orifice through which the sorted positive particle collection well is in fluid connection with the positive particle conduit.

“Particle” is defined as a discrete unit of matter, including, but neither limited to droplets nor to cells. The term particle includes cells as well as other particles, e.g., beads, nuclei, nucleotides, viruses, protein complexes, or proteins, biochemical or chemical compounds, and includes particles contained in droplets. In the present context all droplets, they be single- or double-emulsion droplets, large or small, spherical or elongated, are referred to as droplets. The term droplet is thus used in this patent to include spherical droplets, plugs, and slugs.

The term “positive particle” is used to describe a particle which expresses or may be brought to express the selected identifying characteristics whether the characteristics may be optically-detectable, e.g., specific fluorescent, ultraviolet or color change signals; characteristic light-scatter, -emission or -absorption, or even detectable by signals mediated by radioactive-, electromechanical- or magnetic sources etc.

“PCR” refers to the refer to the Polymerase Chain Reaction technique e.g., as described in U.S. Pat. No. 4,683,195.

The term “negative pressure” is used to denote a situation wherein the pressure applied to the fluids of a conduit is lower than the ambient pressure.

The term “positive pressure” is used to denote a situation wherein the pressure applied to the fluids of a conduit is greater than the ambient pressure.

The term “reagent” as used herein refers to a compound or a set thereof, and/or a composition, which is associated to a sample to perform a specific test on the sample. For example, the reaction reagent may be an amplification reagent, specifically, a primer for amplifying a target nucleic acid, a probe and/or a dye for detecting an amplified product, a polymerase, a nucleotide (e.g., dNTP), a magnesium ion, a potassium chloride, a buffer, or any combination thereof.

The term “sample” as used herein is not particularly limited as long as it contains a specimen to be sorted. A sample may be any liquid volume containing a number of particles. For example, a sample may be a biological sample, such as a biological fluid, a biological entity or an extract of any such items. Examples of the biological fluid include urine, blood, plasma, serum, saliva, semen, faeces, sputum, cerebrospinal fluid, tear fluids, mucus, amniotic fluid, and the like. The biological entity refers to a cell or collection of cells, including bacteria and virus.

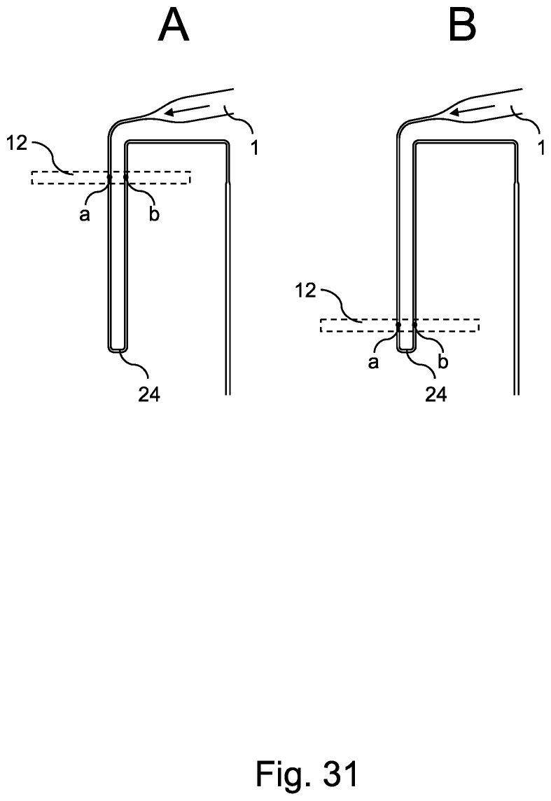

The term “loop time” as used herein is the time it takes a particle to travel from one point in the incoming arm of a detection loop to the corresponding point in the outgoing arm of the detection loop. The concept is illustrated in FIG. 31 showing that the loop time is the time it takes a particle to get from point a to point b in a detection loop.

“XdropSort”: throughout the text XdropSort-system, -instrument, -sorting cartridge or -method may be used to refer to a preferred embodiment of the system, the instrument, the sorting cartridge or a method of sorting by using the system.

Similarly, “Xdrop” may be used to refer to a preferred embodiment of either the single-emulsion generating cartridge (Samplix item #CA20100) or the double-emulsion generating cartridge (Samplix item #CA10100).

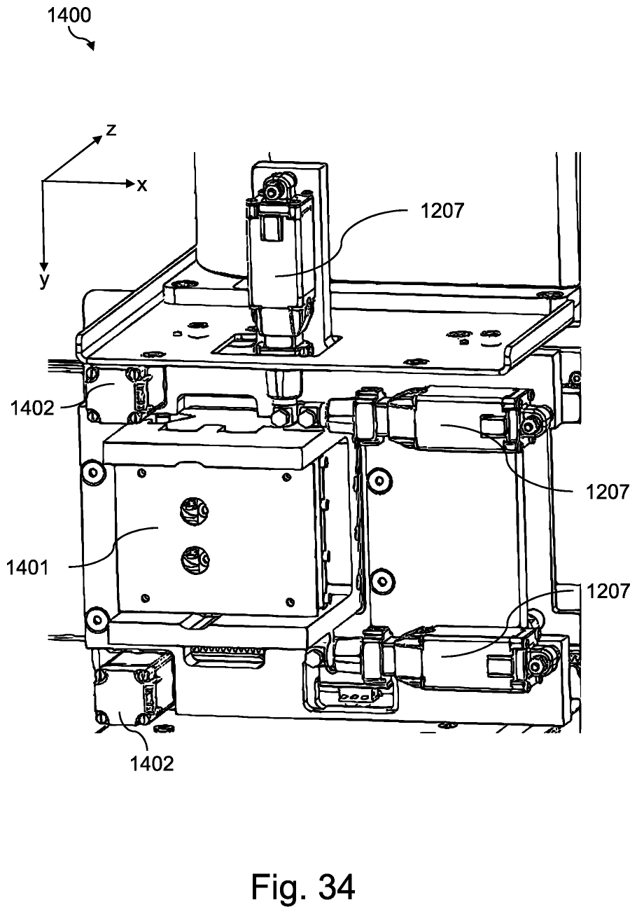

The term “X-Y plane” refer to the plane indicated by the XYZ coordinate system in FIG. 34.

The term “negative carrier particles” refer to particles that do not comprise sample and are not detectable by the detection system of the invention. One example of such negative carrier particles is oil-in-water droplets. Another example is water-oil-water droplets wherein the inner aqueous phase does not comprise compounds that generate a signal in the system.

### DETAILED DESCRIPTION

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. Like elements will, thus, not be described in detail with respect to the description of each figure.

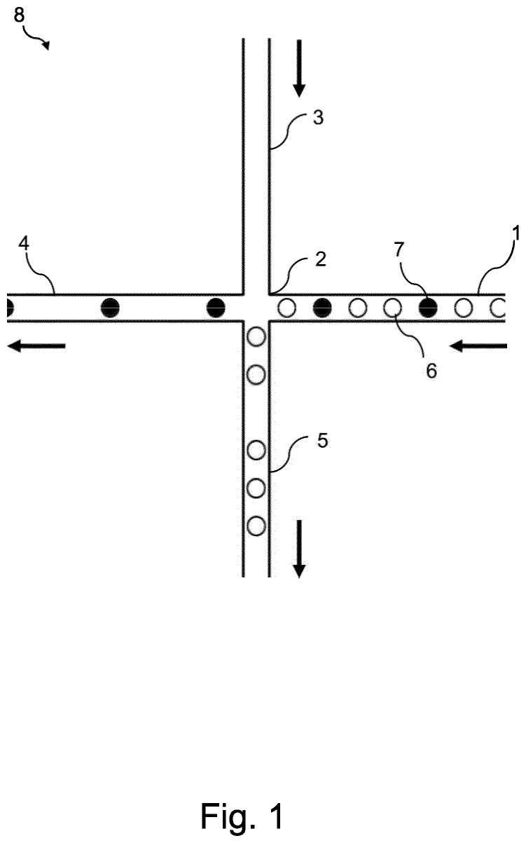

According to the present invention, it is possible to design functional sorting-junctions with three microfluidic conduits meeting at a sorting-junction. The present inventors have found that a junction with at least four microfluidic conduits provides for more effective sorting and significantly lower loss of positive particles. Thus, preferably the invention relates to an embodiment where four microfluidic conduits meet at the sorting-junction [8], and where at least one of said conduits feeds a push-fluid [3] into the sorting-junction. See FIG. 1.

The push-fluid may be supplied at a variable, positive pressure and has the important function to minimise the possible “backwards” flow of negative particles from the negative particle conduit (waste) into the positive particle conduit (sorted positive particles). See example 7. The sorting function may be further enhanced by applying a variable, negative pressure to the sorted positive particle conduit [4] and the waste conduit [5] both of which is carefully controlled by the instrument.

This invention is primarily directed to the sorting of populations of particles, characterized in a low to a very low ratio of positive particles to total number of particles (frequency of positive particles).

Accordingly, a number of measures have been taken to accomplish the sorting of a very large number of particles in a relatively short time.

One measure may be to load particles at a high concentration into the sample feeding conduit [1]. However, to accomplish an effective sorting at the junction point [2] the inventors have realised that the particles should be spaced so they pass through a detection zone and enters the sorting-junction [2] primarily one by one. In preferred embodiments this is obtained by designing the one or more microfluidic sorting-units to comprise a spacer-fluid conduit and spacer-fluid junction placed upstream of the sorting-junction point to feed a spacer-fluid into the fluid of particles to be sorted. See example 8.

The spacer-fluid may be supplied at a variable, positive pressure, which is carefully monitored and controlled by the instrument.

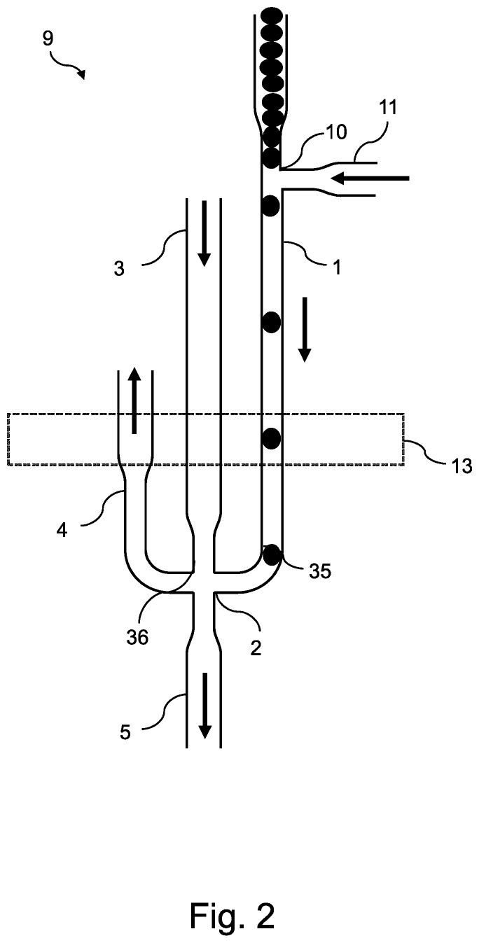

FIG. 2 is a schematic illustration of one embodiment of the central part of a sorting-unit [9] showing the upstream spacer-fluid conduit [11] and spacer-fluid junction [10]. Arrows indicate direction of fluid-flow. Particles are indicated by black ovals.

The system is designed to detect positive particles at a detection zone placed downstream of the spacer-fluid junction [10]. The dotted line [13] indicates the location of this detection zone in one embodiment. The function of this, downstream detection zone [13] is to trigger a sorting event at the junction point [2] in response to the detection of a positive particle in the detection zone.

Whereas the positive particles may be detected based on any identifying characteristics it is preferred that the identifying characteristics of positive particles may be optically detected.

In preferred embodiments the detection of a positive particle implies a laser-induced fluorescent signal.

To facilitate a system with interchangeable single-use cartridges, systems wherein the laser and the fluorescent signal detection system both is part of the instrument are preferred.

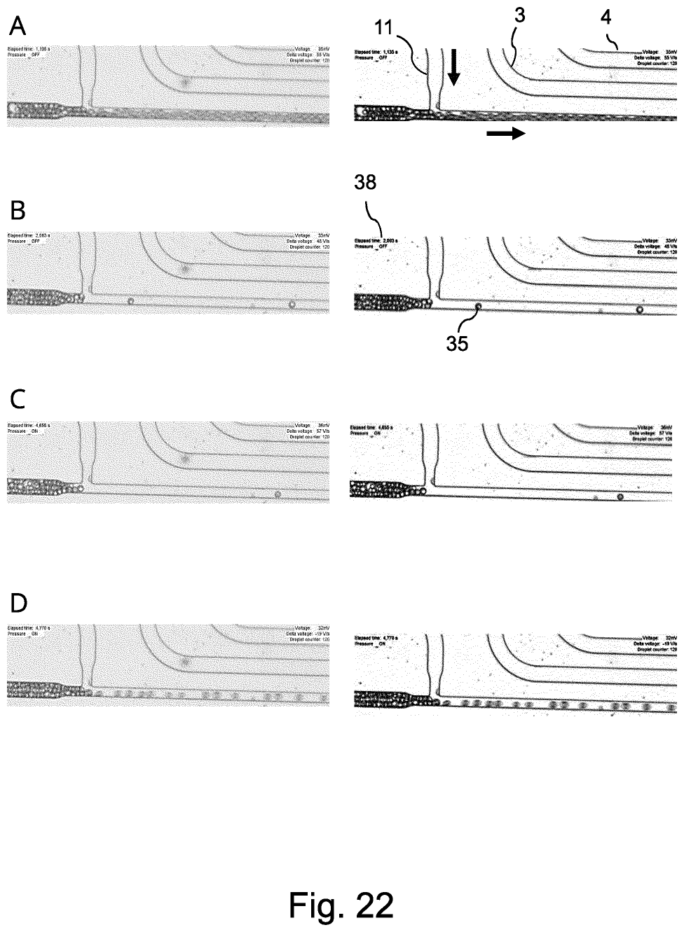

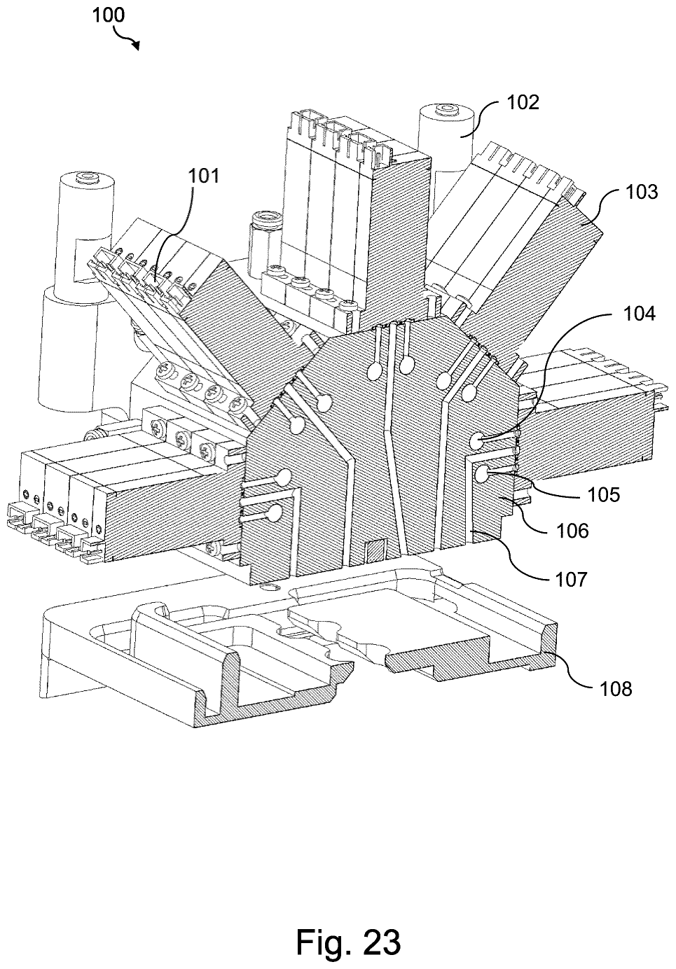

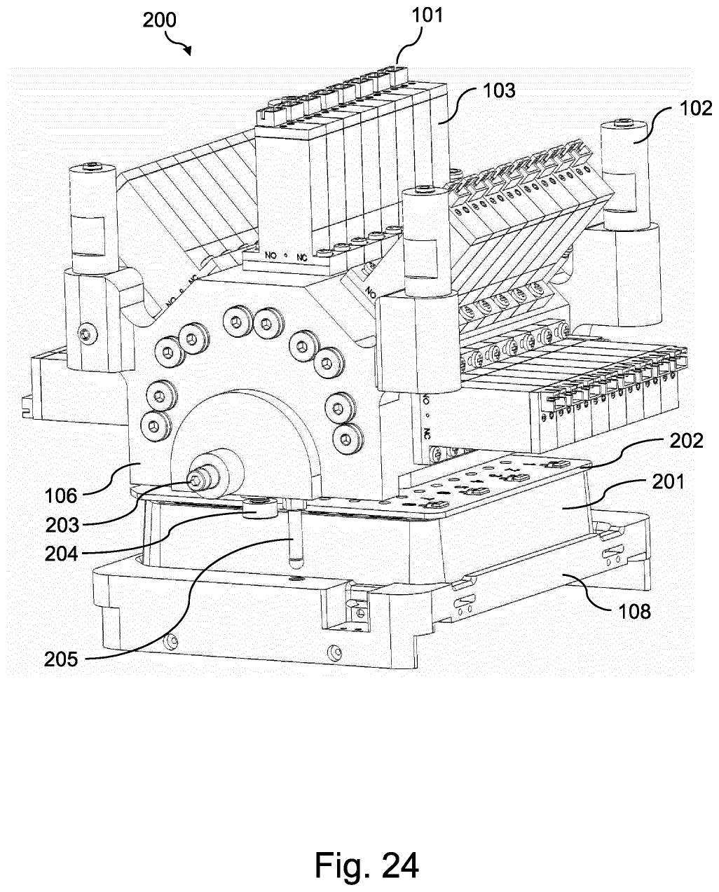

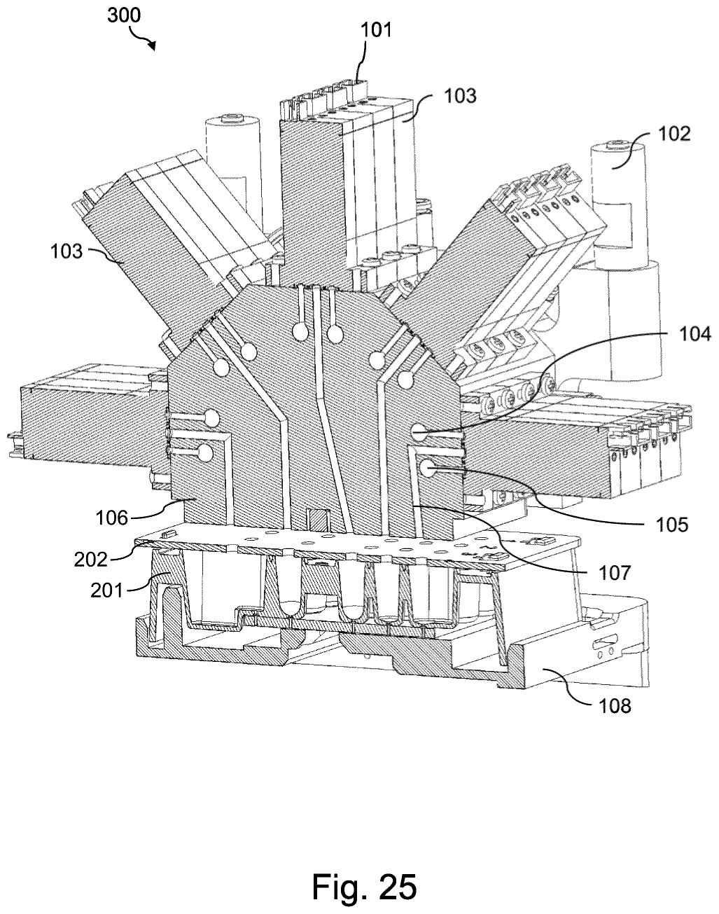

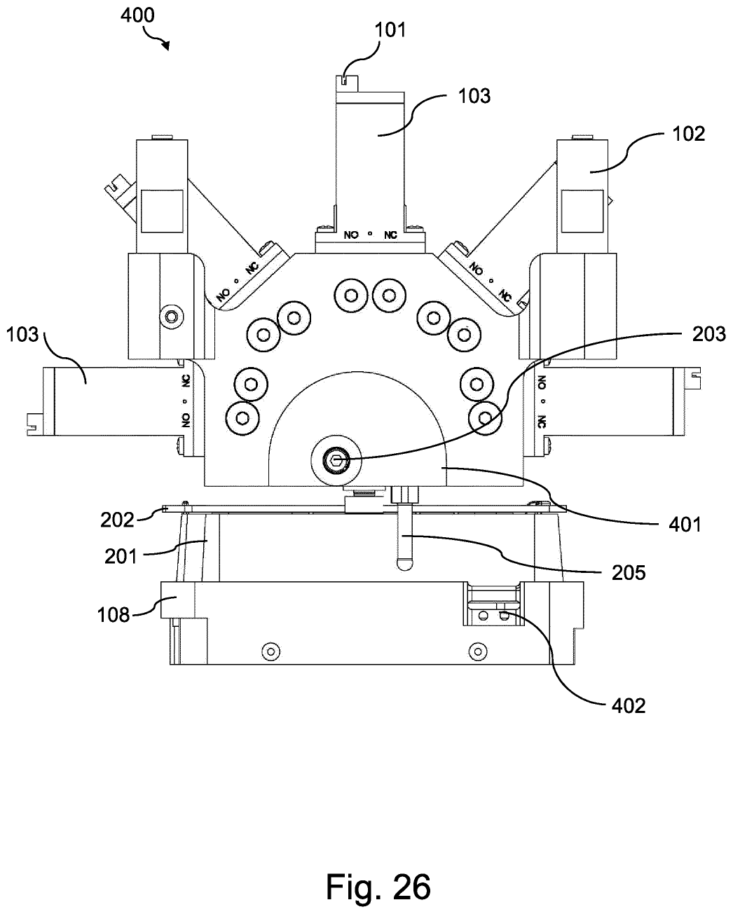

The passage of the particles one by one with sufficient space between the particles to allow for efficient sorting, see FIG. 22, is induced by a pneumatic force invoked on the spacer-fluid inlet [18] in response to the detection of a positive particle upstream of the sorting-junction would lead to unacceptable long sorting times if not other measures were taken.

This obstacle was overcome with the instrument which controls the flow of fluids through the microfluidic sorting-units and which regulates the flow rate of particles in the feeding conduit in response to detecting positive particles in the feeding conduit upstream of the sorting-junction. The innovative concept is that the flow rate of particles in the sample feeding conduit is only temporarily reduced after the detection of a positive particle at a detection zone upstream of the sorting-junction.

Depending on the specific embodiment the flow rate of particles in the feeding conduit is temporarily reduced only for a short period of time after the detection of a positive particle upstream of the sorting-junction. In most embodiments this time is significantly less than 5 seconds, e.g., less than 1 s or 500 ms or even less than 50 ms and is followed by an immediate increase of the flow rate. See example 4, 5 and 8.

The spacer-fluid input into the sample feeding conduit is supplied at a variable, positive pressure. It comprises an important part of the crucial change of flowrate through the sorting-unit and is carefully monitored and controlled by the instrument.

The result is an effective sorting of a large number of particles. In case of an embodiment wherein the cartridge comprises eight sorting lanes calculations show that the sorting capacity of the system may exceed 28.000 particles per second. Data presented in example 5 indicate even higher sorting rates may be expected for populations of particles characterised by relatively few positive particles amongst many negative particles.

Although the switching frequency of a pneumatic sorting system is lower that the switching frequencies obtainable with e.g., dielectrophoretic devices or optical tweezers, a system wherein the sorting event is induced by pneumatic force provides significant advantages.

One advantage is that the system may comprise a simpler cartridge without moving parts or built-in actuators and opens for an instrument based on standard components such as commercially available valves and pumps.

A pneumatic sorting system is also advantageous because it is adaptable to low-cost sorting cartridges without moving components and thus to single-use cartridge-designs that do not require extensive cleaning of the instrument between different runs. Furthermore, it may be assembled from standard components whereby the cost is reduced.

In preferred embodiments the system comprises a low-cost cartridge which is removable from the instrument and adapted for single use. Such a cartridge may be designed to ensure no or only minimal carry-over or contamination of the instrument, making time-consuming cleaning-cycles known from e.g., FACS-sorters obsolete.

To provide for minimal carry-over or contamination of the instrument, the cartridge may comprise a set of wells of a sufficient size to contain all fluids needed for the sorting including the complete volume of sample, waste, buffers and sorted positive particles.

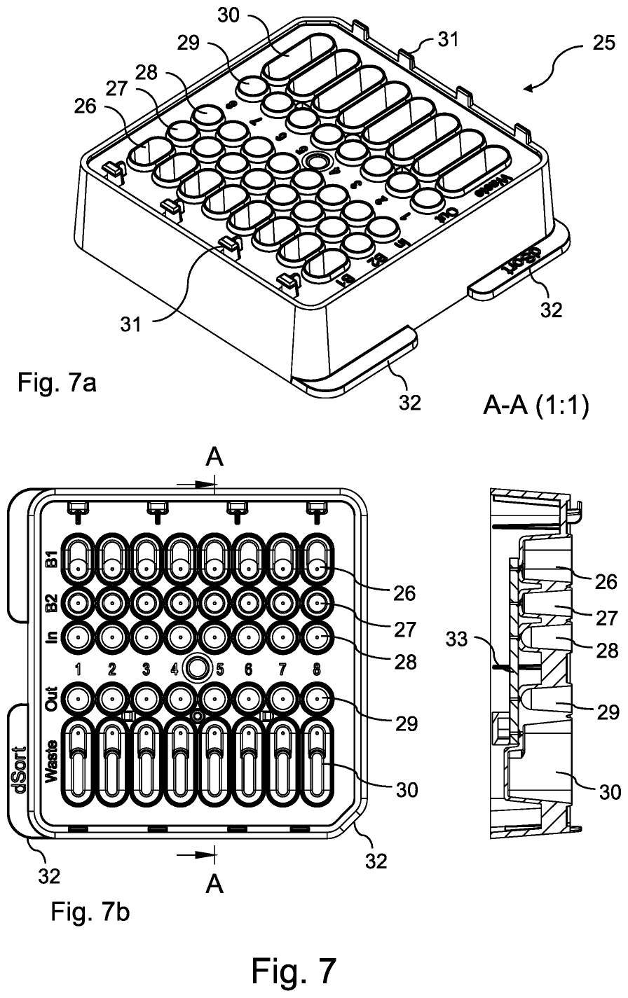

One embodiment of such a cartridge is illustrated in FIG. 7. In preferred embodiments the cartridge comprises two or more sorting lanes, wherein the sorting lanes may be organized in pairs.

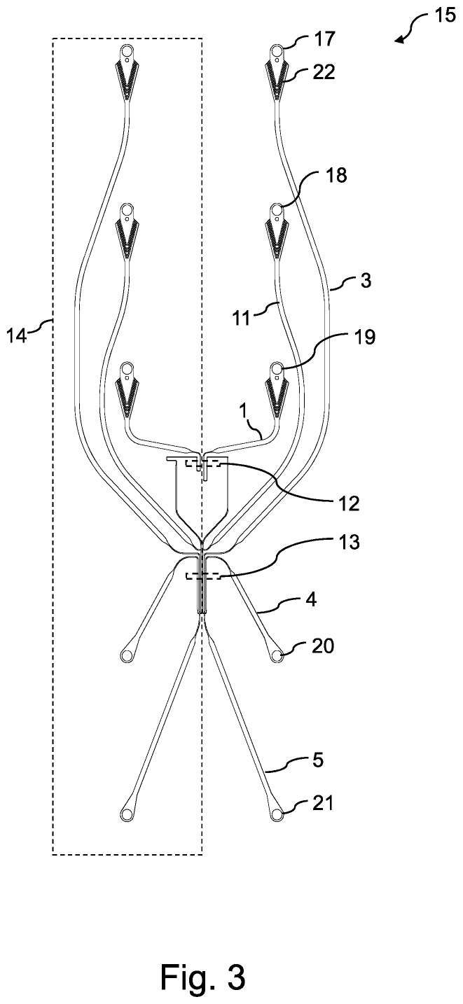

FIG. 3 shows one design of a pair of sorting lanes [14].

Importantly, the figure also shows that in this preferred embodiment each one detection zone comprises parts of two separate particle feeding conduits of a sorting lane pair.

The embodiment shown in FIG. 3 also indicate that the inlets from the push-fluid-, spacer-fluid-, and suspended particle-wells may comprise a filter [22] to avoid that durst etc. enters the microfluidic system.

Whereas several types of filter may serve this purpose, a pillar filter, e.g., of a type having a distance between the perimeter of each pillar of between 15 to 100 μm is preferred. The cross-section of each pillar may be of any shape such as round, square, triangular kite, or trapezoid.

The organisation of the sorting lanes in pairs has the important effect that one detection-zone can be designed to detects signals from two separate droplet sorting lanes.

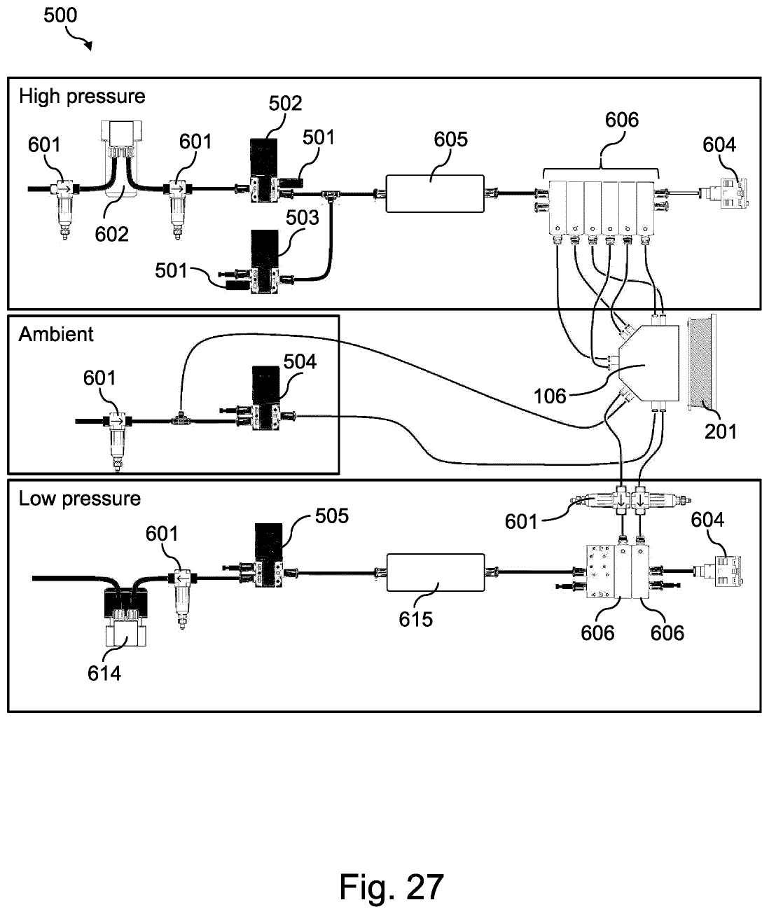

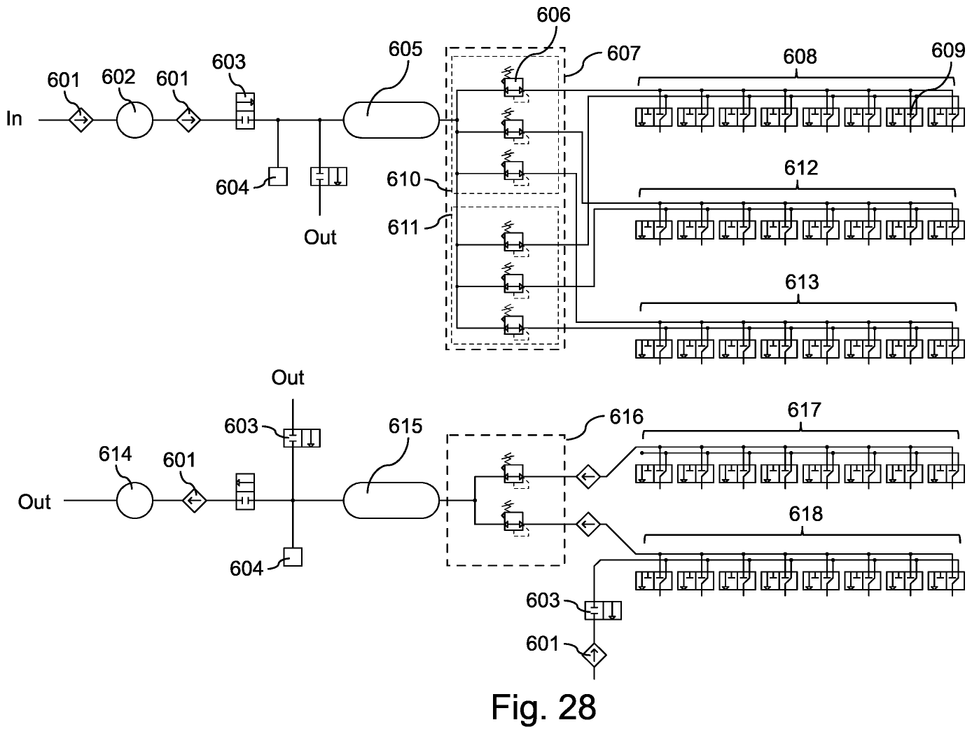

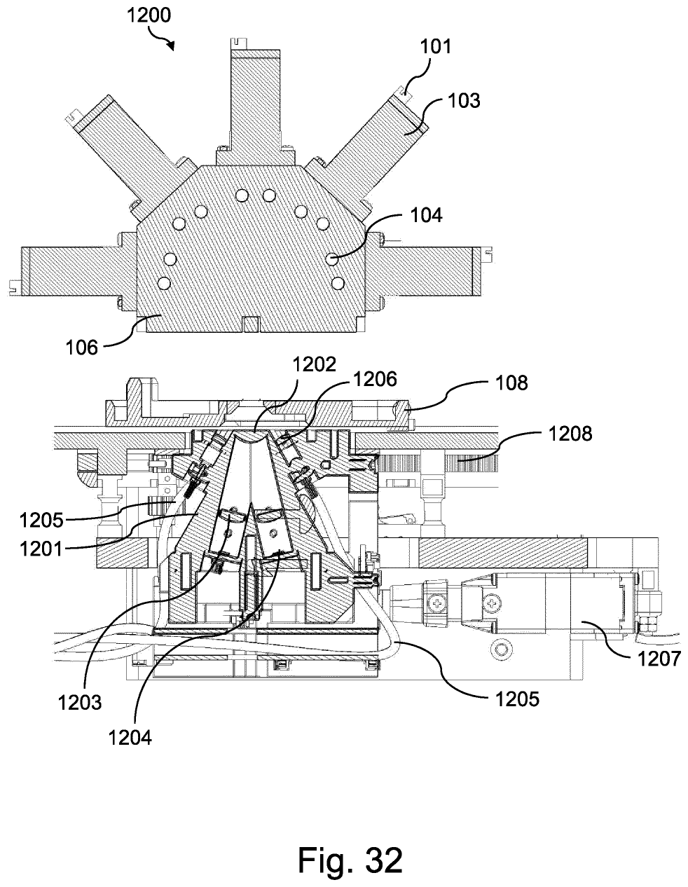

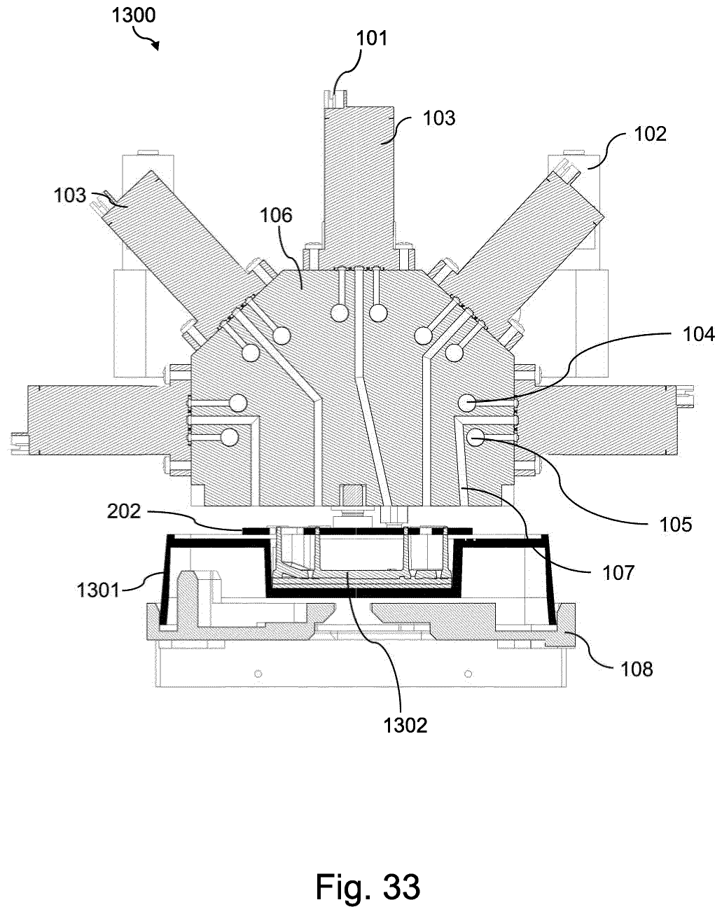

In the preferred situation where the detection of positive particles implies a laser-induced fluorescent signal, and where both the laser and the fluorescent signal detection system is part of the instrument, see FIG. 32, the mere physical extent of the laser and the optics of the signal detection system may be a challenge for the miniaturisation of the microfluidic part of the system. In particularly in embodiments comprising plural (e.g., 8) individual sorting-units, size matters. The organisation of the sorting lanes in pairs allow one laser- and detection system to monitor two separate droplet sorting lanes and save space. Furthermore, the dual-lane detection zones also result in a simpler and less expensive instrument. Furthermore, to make the instrument even simpler and less expensive more parallel sorting lanes may be pneumatically connected to the same pressure supply, see FIGS. 27 and 28.

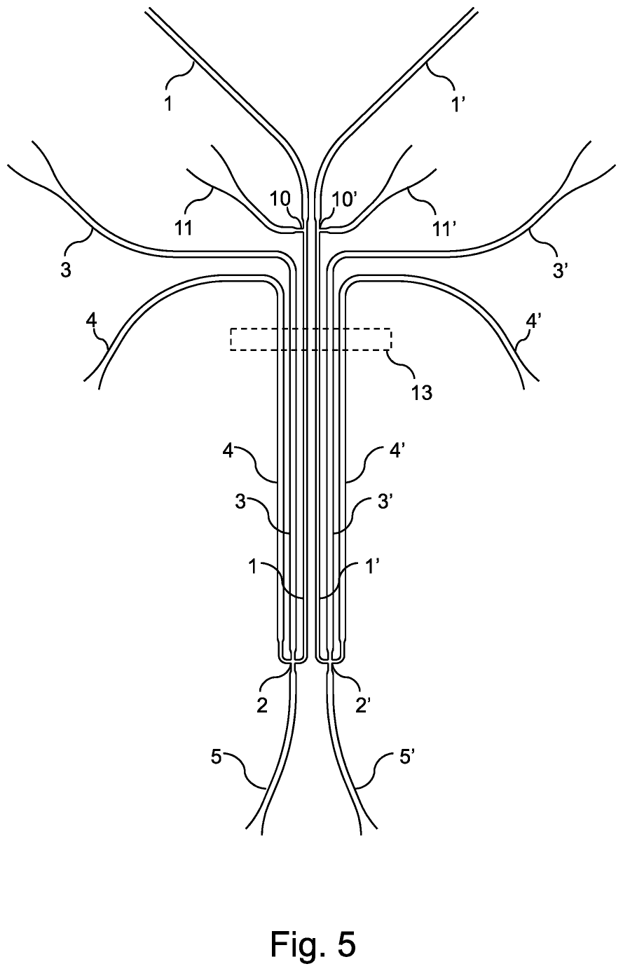

As indicated in FIG. 3, each pair of sorting lanes comprises two separate detection zones, wherein one upstream detection zone [12] is placed upstream of the spacer-fluid inlet [10] detecting droplets before they reach the sorting-junction [2], and where the other downstream detection zone [13] is placed downstream of the spacer-fluid inlet to detect positive droplets before they enter the sorting-junction [2]. Further details may be seen in FIG. 5.

The upstream detection zone is used to detect a positive particle, and in response to the detection the instrument a) transiently down-modulate the flowrate through the sorting-unit; and b) determine whether the positive signal came from one or the other lane.

The discrimination between whether the positive signal came from one or the other lane is brought about by a design wherein each of the two sample feeding conduits comprise a detection loop, and wherein the two detection loops may be of different lengths.

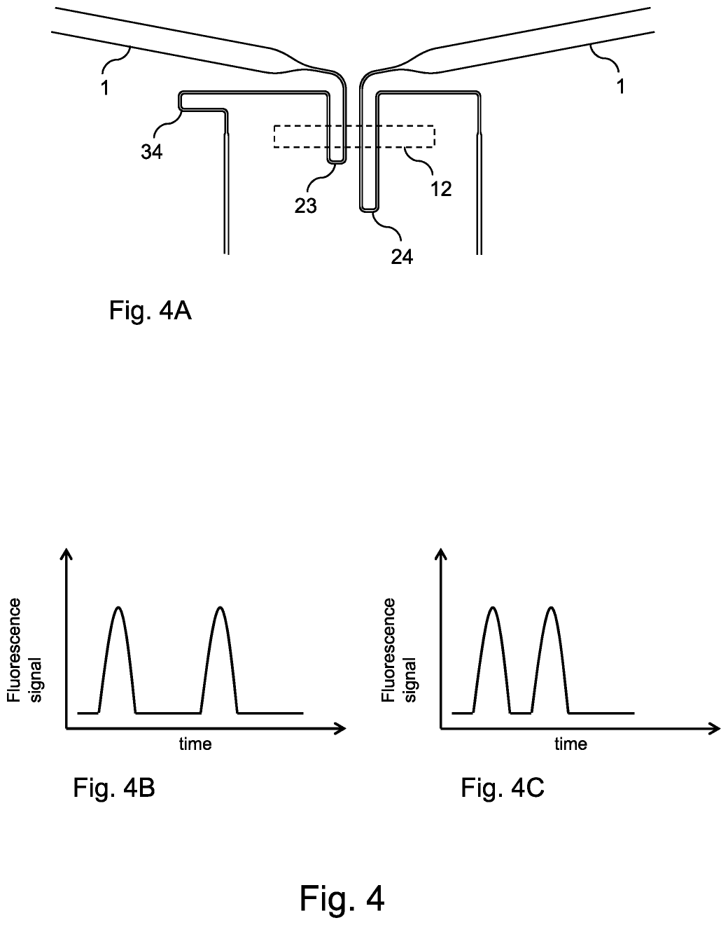

The principle for discrimination is illustrated in FIG. 4.

Briefly, particles are flowing into the upstream detection zone [12] from the two sample feeding conduits [1] of a pair of sorting lanes. The instrument is providing pressures to make particles flow into both conduits at (approximately) comparable flow rates. As a result of the different lengths of the two detection loops [23, and 24], the time difference between the first (downwards) pass and the second (upwards) pass through the detection zone is different for the two loops (long and short). The time difference between a particle detected for the first time (on its way into the detection zone) and the second time (on its way out of the detection zone), may be referred to as the “loop time delta”.

This difference in “loop time delta”, illustrated in FIGS. 4B and 4C, is used to determine if a particle was observed the in long or the short detection loop. Whereas the “loop time”, i.e., the time it takes an particle to travel from one point in the incoming arm of a detection loop to the corresponding point in the outgoing arm of the detection loop, is illustrated in FIG. 31, and is used to align the sorting cartridge [25]/[201] and the optical head [1201].

In typical embodiments this information is used to slow down the flow of fluid in the sorting lane, wherein the positive particle was detected, while the other side (where no particle was detected) is left unchanged, continuing to operate at the initial fast speed.

An optional design comprising an extra loop [34] on the feeding conduit which comprise the short detection loop, makes the total length of the two particle feeding conduits of a pair similar.

FIG. 3 also indicates localisation and extent of the downstream detection zone [13] of an embodiment of the invention. FIG. 5 is a close up of this part of the cartridge in the most preferred embodiment.

The function of the downstream detection zone [13] is twofold.

1) to trigger a sorting event at the junction point [2] in response to the detection of a positive particle entering this detection zone through the sample feeding conduits [1, and 1′], and 2) the downstream detection zone may also serve to detect whether a correct sorting has occurred. The time difference between a particle detected first time (on its way into the downstream detection zone) and, in case of a successful sorting, the second time (on its way out of the detection zone), is used to identify a successful sorting event, and may provide other valuable data as well. It may e.g., be used to quantitate the amount of various compounds (e.g., specific nucleic acids) in the sample.

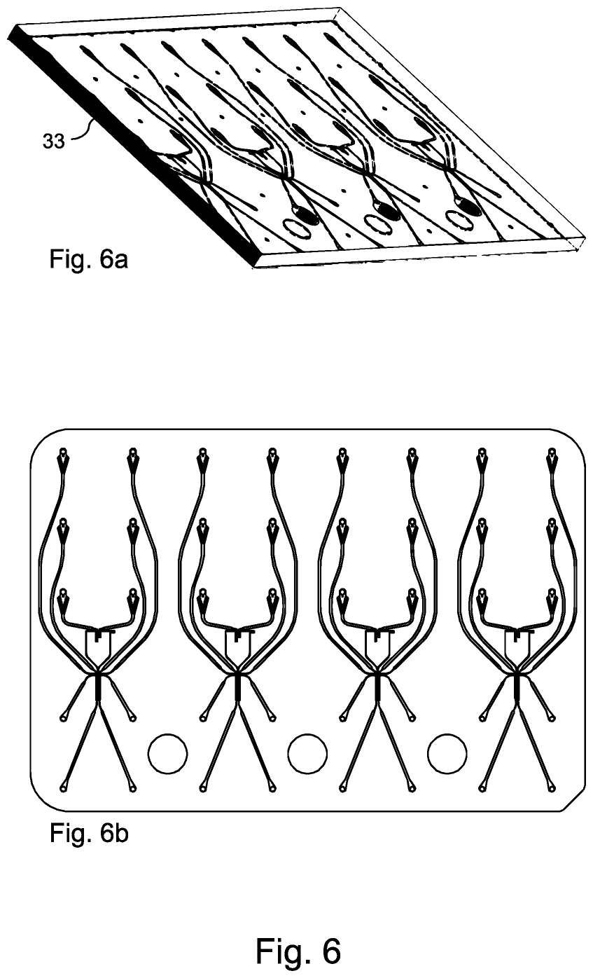

Sorting speed is of the highest importance to the present invention. The pairwise organisation of sorting lanes makes embodiments of the cartridge comprising plural (e.g., 8) individual sorting-units possible. One embodiment is shown in FIGS. 6 and 7 wherein the cartridge comprises eight sorting lanes organized in four pairs. A system comprising such a cartridge may sort more than 28.000 particles per second.

The system may be used to sort many types of discrete units of matter, e.g., droplets and cells including eukaryotic cells, e.g., mammalian cells, as well as other particles, e.g., viruses, protein complexes, or proteins, and including particles contained in droplets.

A particular preferred embodiment is a system specially adapted to sort droplets. The droplets may be single- or double-emulsion droplets and may be droplets both with and without encapsulated particular matter such as cells.

In any case the droplet emulsion is formed in a separate action before the droplets are loaded into the system for sorting.

There are more methods and devices for forming single- or double-emulsion droplets. Two particularly relevant approaches to form either single- or double-emulsion droplets are described in PCT/EP2020/052409 and PCT/EP2020/052400. In both PCT/EP2020/052409 and PCT/EP2020/052400 the systems for generating droplets imply a single-use cartridge and an instrument all of which are currently marketed and commercially available from Samplix Aps, Herlev, Denmark. The Xdrop instrument (item #IN00100, Samplix ApS, Herlev, Denmark) is designed to perform this task in combination with either the single-emulsion generating cartridge (Samplix item #CA20100) or the double-emulsion generating cartridge (Samplix item #CA10100).

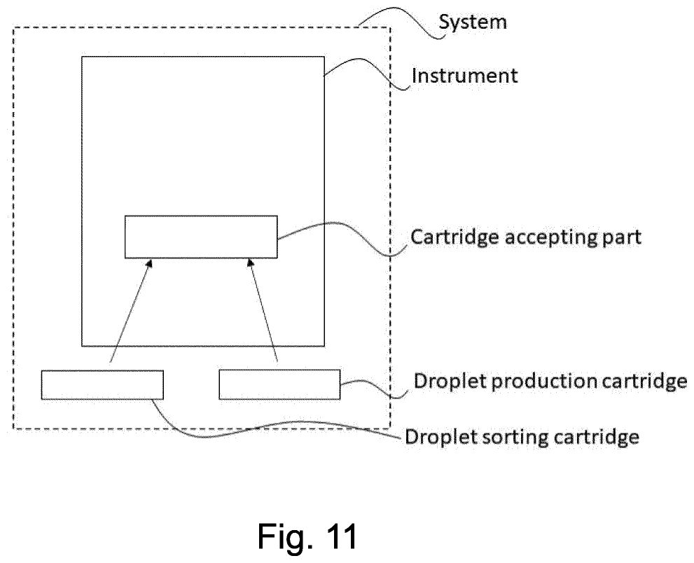

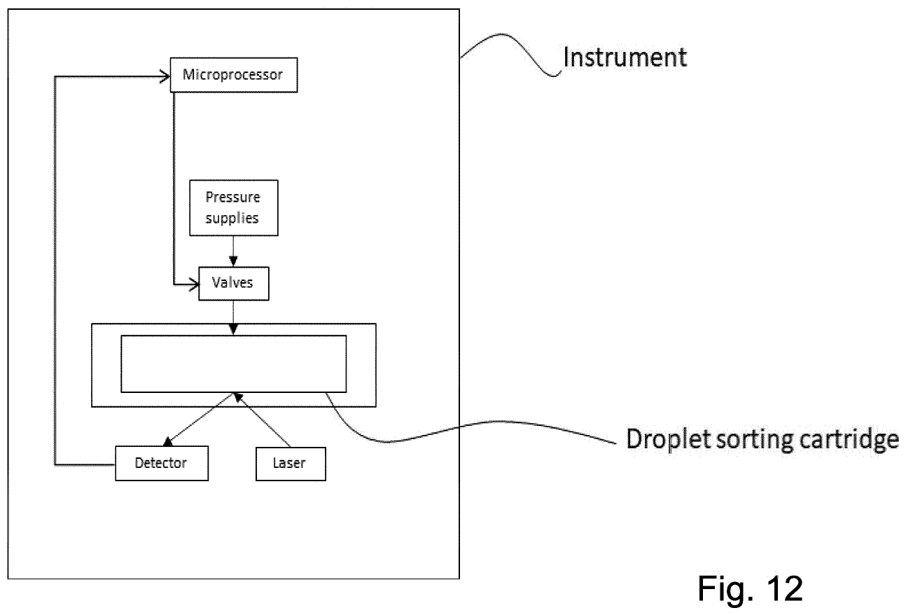

Further to improve the use of the present invention in certain embodiments, the instrument of the invention, in addition to fit the cartridge, control and drive the fluids through the cartridge it also fits, controls and drives the fluids through a cartridge made to produce single emulsion droplets as well as a cartridge made to produce double emulsion droplets such as the cartridges described in PCT/EP2020/052409 and PCT/EP2020/052400 and marketed by Samplix ApS, Herlev, Denmark. This “multi-purpose” functionality is further illustrated in FIG. 11 and example 5.

Some important embodiments of the system, as they appear in the examples, are systems and methods directed to the sorting of double emulsion droplets. In such systems both the preferred push-fluid and the spacer-fluid are aqueous.

In preferred embodiments of the invention the cartridge, see FIGS. 6 and 7, comprises at least eight sorting lanes organized in four pairs. To minimise the loss and facilitate recovery of sorted droplets the sorted positive particle collection well [29] has a bottom part having an inclining surface wherein the orifice of the collection well is provided at the lowermost part of said collection well.

In general, the fluid conduits of the sorting-junction [8] is in the microscale, i.e. the conduits comprise parts that are less than 200 μm wide and less than 200 μm deep, preferably less than 100 μm wide and less than 100 μm deep or even less than 50 μm wide and less than 50 μm deep.

To ensure that the cartridge is correctly inserted into the instrument the cartridge may be designed asymmetrically thus only fitting into the instrument when correctly inserted. See FIG. 7.

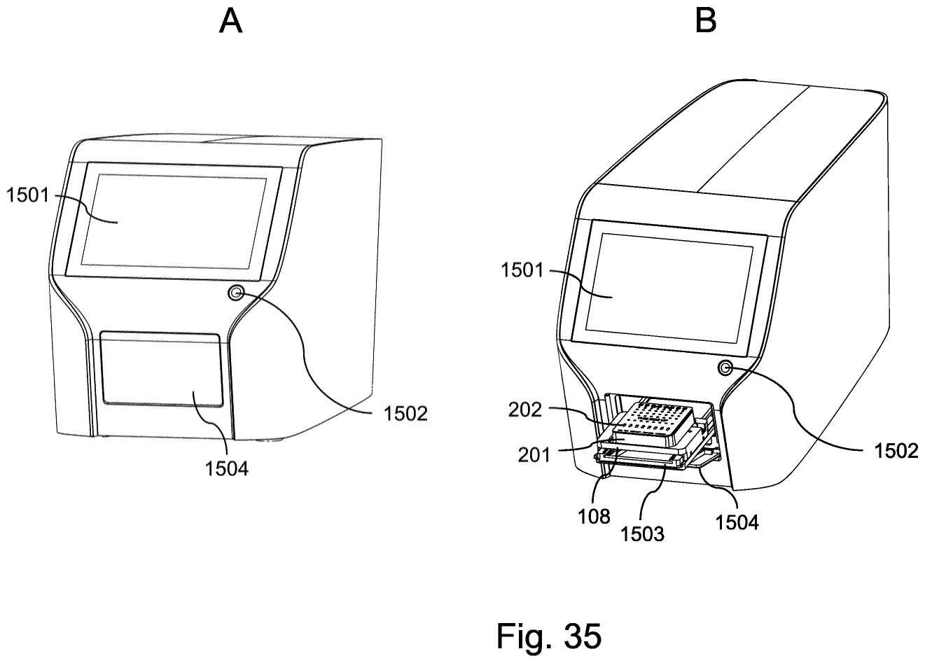

A preferred embodiment of the instrument-part of the system is shown if FIG. 35. Panel A show the instrument with closed door [1504]. Panel B show the instrument with open door, the drawer extracted and with an XdropSort cartridge [25]/[201] inserted into the cartridge support tray [108].

The instrument may comprise an optical head which forms an integrated unit, see FIG. 32 [1201]. The optical head comprises the optical system that forms 2 linear detection zones, referred to as the upstream and the downstream detection zones, or DZ1 and DZ2. The optical head further comprises the optics and the detectors needed for detection of positive particles.

Whereas particles may be detected in the detection zones by any type of light. It is preferred that positive particles are detected by a laser-induced fluorescent signal.

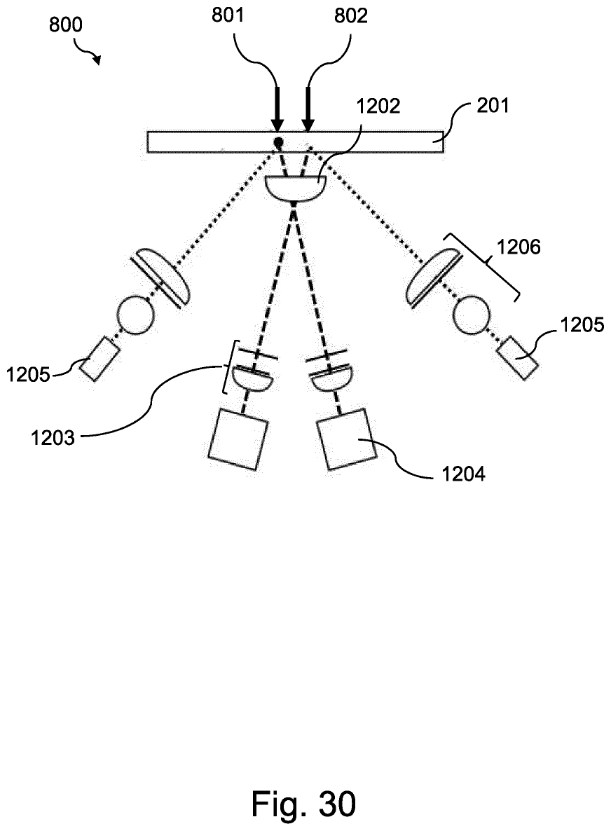

To save space and miniaturise the optical system the instrument may be equipped with an optical head wherein the fluorescent signal emitted from positive particles both in the upstream and the downstream detection zones are collected through at least one same single lens. See FIG. 30.

In a preferred embodiment, laser light of approximately 488 nm is directed through a light guide [1205] to two lens-systems [1206] each of which creates a line of laser light of approximately 250×2000 μm on the microfluidic section and forms the two detection-zones [801] and [802]. Filters ensure that light of wavelengths other than approximately 488 nm is reduced.

The arrangement allows an arrangement with only one collection lens for both detection zones. Filters on the detection side [1203] allow 515 nm light to pass and reduce light of other wavelengths.

Although the cartridge is made of precision produced plastic the optical system and the cartridge needs to be aligned before each run. Accordingly, the instrument may comprise an alignment system which align the cartridge with the optical system.

The alignment may be accomplished by an alignment system comprising 3 actuators which align the optical system and the cartridge by moving the optical head in the X-Y plane, see FIGS. 32 and 34.

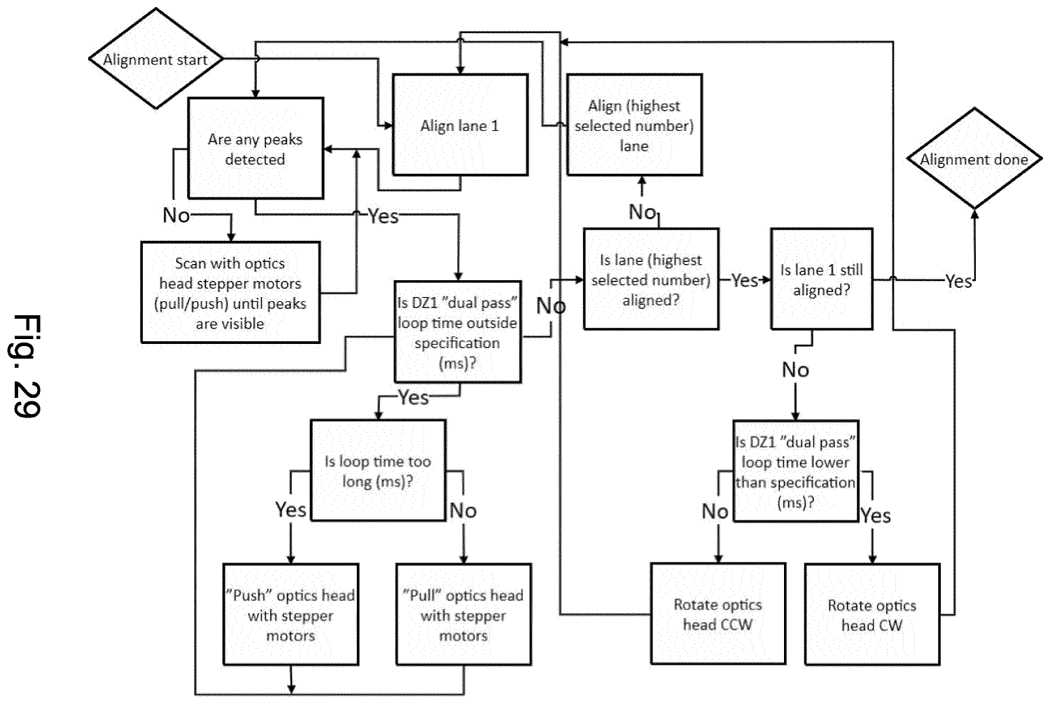

User convenience has been at focus in the development of the instrument, accordingly in a preferred embodiment the alignment system automatically aligns the optical head and the cartridge. The algorithm that governs this is illustrated by the flow diagram in FIG. 29.

Central to the alignment process is the concept of “loop time” illustrated in FIG. 31. Briefly, “loop time” is the time it takes a droplet to get from “point a” in the incoming part of the detection loop [24] to “point b” in the out-going part of the detection loop. The detection zone [12] is designed to allow the estimation of the loop time. The sensitivity of the optical system can (automatically) be adjusted to detect all particles in a sample. It may be appreciated that the loop time in situation A is a relative long loop time, whereas in situation B the loop time is relative short. The alignment then occurs by aligning the optical head and the cassette until the loop time in at least two lanes, typically of lane 1 (or 2) and lane 7 (or 8), both are within preselected limits.

The instrument controls the flow of fluids through the at least one microfluidic sorting-unit by a pneumatic system which operates with both variable, positive and with variable, negative pressures. In a preferred embodiment the pneumatic system is connected to the microfluidic system of the sorting cartridge [201] via a manifold [106], see FIG. 27. A gasket [202] ensure that the connection is air-tight when the cartridge and gasket is inserted into the cartridge support tray [108] and the instrument is in the closed configuration, FIG. 35. In this configuration the cartridge is air-tight clamped to the manifold.

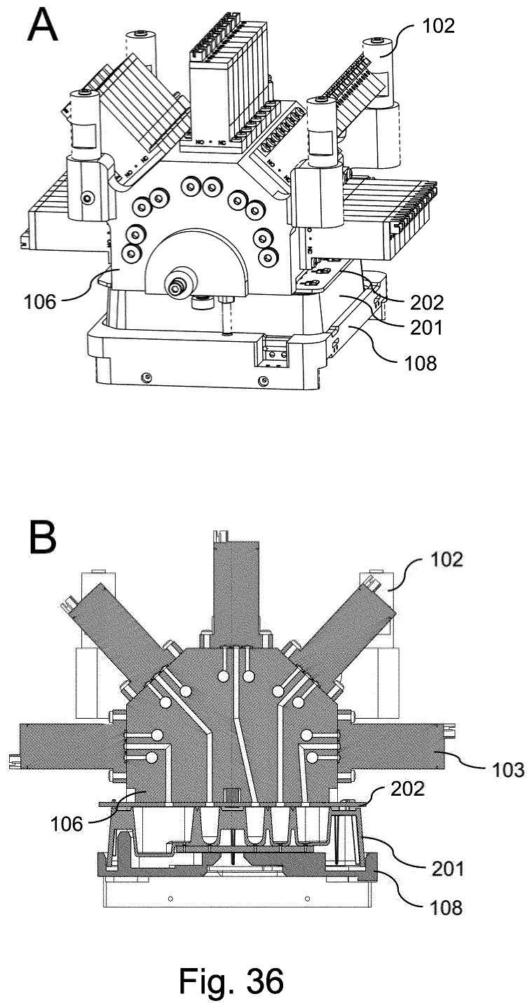

In closed configuration the manifold is lowered onto the gasket of the cartridge to clamp the cartridge to the manifold as illustrated in FIG. 36.

To direct the flow of fluids through the microfluidic device inserted into the instrument, the pneumatic system of the instrument comprises a set of directional control valves which are able to subject the fluids in the microfluidic system with high variable positive pressures or low variable positive pressures, and a different set of directional control valves which are able to subject the fluids in the microfluidic system with variable negative pressures or an ambient pressure.

FIG. 28 illustrate one embodiment of the pneumatic system. The three inlets the particle sample inlet [19], the spacer-fluid inlet [18], and the push-fluid inlet [17] of the cartridge (see e.g., FIG. 3) are operatively connected via the manifold to a pressure system consisting of six different positive pressures see diagram FIG. 28. One set of 3 pressure-conduits are operated with relatively high pressure (e.g., 600-1800 mbarg). The other set of 3 pressure-conduits are operated with relatively low pressure (e.g., 100-500 mbarg). The specific pressure in all 6 pressure-conduits is finely regulated by 6 electronic pressure regulators [606] which are connected to a pressure air vessel [605]

In this embodiment each of the inlets for push-fluid [608]/[17], spacer buffer [612]/[18] and droplet buffer/particle sample [613]/[19] are fed with either high or low pressure and is controlled by a set of 3/2 direction valves.

Also the outlets for the sorted positive particles [617]/[20] and waste [618]/[21] may receive two different pressures being ambient (0 bar) or a moderate negative pressure (e.g., −100 to −400 mbarg) which is also controlled by a set of 3/2 direction valves. The valves on the negative pressure side are also controlled by signal from the detection system.

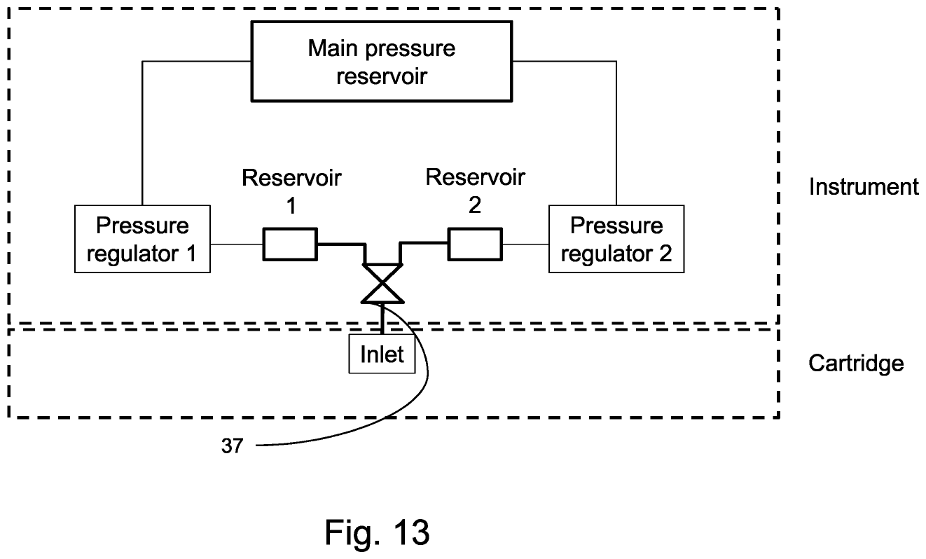

This configuration—which also is illustrated in FIG. 13—provides for a significant shorter response time, compared to a configuration wherein the pressure over the various in- and out-lets to the sorting cartridge are regulated by pressure regulators. Example 9 illustrate enrichment of positive droplets using preferred embodiments of the instrument and the particle sorting-cartridge. The instrument and cartridge may be referred as XdropSort-instrument and -cartridge, whereas the complete system may be called the XdropSort-system.

Interestingly, the XdropSort-instrument and -cartridge can also sort cells including eukaryotic cells, e.g., mammalian cells in single cell suspension that are not encapsulated in droplets, see example 10.

The above described system is specifically designed for sorting of particles, in particularly droplets, by a method, which comprises the steps of: 1) providing a sample of particles, the particles may e.g. be double emulsion droplets, 2) preparing the microfluidic cartridge by pipetting a volume of push-fluid, spacer-fluid and the particle sample into the three relevant supply wells of the microfluidic cartridge, 3) inserting the cartridge into the instrument, 4) setting the instrument and starting the sorting, and 5) after the sorting is complete, transferring the sorted positive particles into a suitable container, and discarding the cartridge.

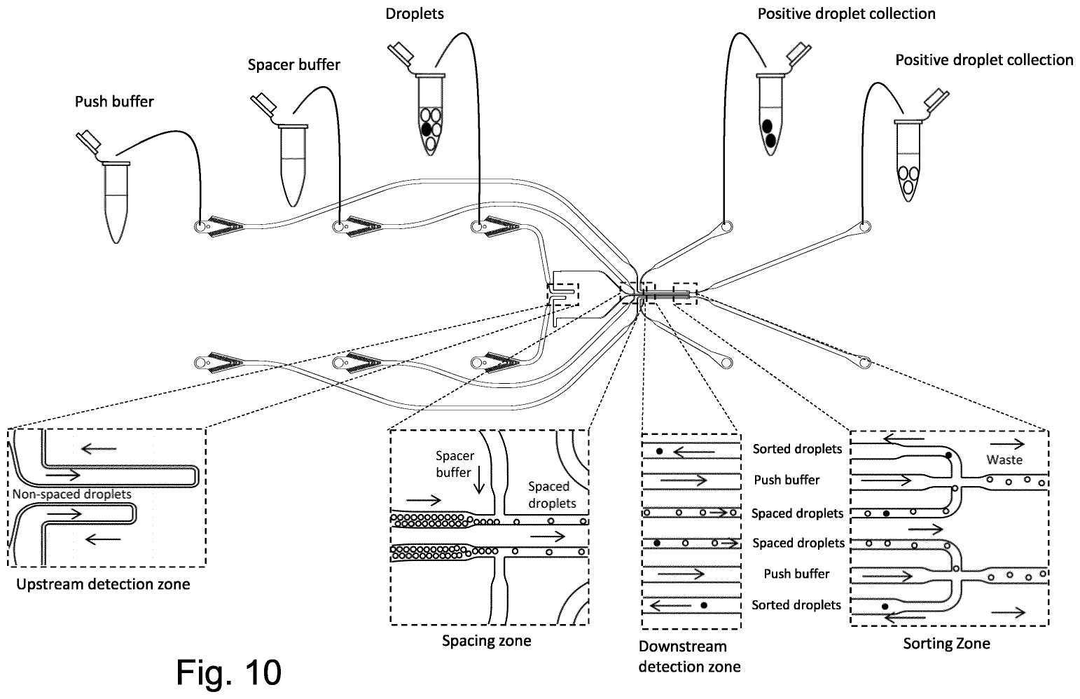

An overview of the method is showed in FIG. 10.

To obtain the benefits of the present system it is recommended that the instrument is set so that the flow rate of particles is temporarily decreased in response to a positive signal detected by the instrument at the upstream detection zone [12] of the cartridge.

As shown in example 3, 4 and 7 the temporary reduction of the flowrate may last between 2 and 0.1 seconds. The optimal time for the temporary reduction of the flowrate depends on the viscosity of the sample of particles and needs to be experimentally established.

Experiments show that the method may be further improved if the spacer-fluid fed through spacer-fluid junction contains negative carrier droplets or particles. Negative carrier droplets or particles may also be added to any well of the cartridge to fill cavities and surfaces thereby reducing loss of positive droplets or particles. In an embodiment, between 1 and 20 μL of negative carrier droplets are added to at least one sorted particles outlet of a cartridge.

One of the major applications of the system is to use it for an in-vitro method for enriching for one or more target molecules from a sample of mixed comprising the steps of: 1) providing a sample of the mixed molecules and contact it with reagents for a specific detection of at least one of said target molecules, 2) formation of suspension of particulate matter comprising the mixed molecules from the sample, 3) incubating the suspension to obtain a specific reaction which is detectable by the instrument of the invention in particles comprising one or more specific target molecule, 4) loading the reacted particles into the system, 5) sorting the particles by use of the system of this invention, and 6) collecting the sorted positive particles in a suitable container for further analysis.

A particularly preferred embodiment of the in-vitro enriching method relate to the enriching for one or more target DNA molecules from a sample of mixed nucleic acid molecules comprising the steps of: 1) providing a liquid sample of mixed nucleic acid molecules comprising one or more specific target DNA molecule and reagents for a specific detection of at least one of said target DNA molecules, 2) formation of an emulsion of a multiple of double-emulsion liquid droplets each comprising mixed nucleic acid molecules from said liquid sample, 3) incubating the emulsion liquid droplets to obtain a specific detectable reaction in droplets containing one or more specific target nucleic acid molecule, 4) loading the reacted droplets into the system for sorting droplets according, 5) sorting the microdroplets by use of the system of this invention, 6) collecting the sorted droplets in a suitable container, coalescing the sorted droplets, and 7) subjecting the selected, coalesced droplets from step 6) to a general amplification procedure.

In this method, the nucleic acid molecules are preferably DNA molecules. The preferred reagents for the specific detection are PCR reagents and the specific detection of said one or more target nucleic acid molecule is performed by PCR (or reverse transcription PCR) and the preferred method for the general amplification procedure is Multiple Displacement Amplification.

It will be appreciated, that the functionality of the invention is critically dependent on the actual cartridge and the reagents used, accordingly a kit of parts for carrying out the method is provided.

In one preferred embodiment the kit of parts comprises at least one cartridge according to the invention; at least one gasket to fit the at least one cartridge tightly to the system of the invention, particularly to a pneumatic system of the instrument, a vial of buffer fluid, e.g., push buffer, and/or a vial of spacer-fluid in an amount sufficient to perform the number of sorting's provided for by the at least one cartridge of the kit.

The push buffer and spacer-fluid may be identical and may be supplied in one vial.

Any relevant part of the above disclosure may be understood in view of the below list of references in combination with the disclosed drawings.

| | |
|---|---|
| [1] | Sample feeding conduit |
| [2] | Junction point |
| [3] | Push-fluid conduit |
| [4] | Positive particle conduit (sorted positive particles) |
| [5] | Negative particle conduit (waste) |
| [6] | Negative particle |
| [7] | Positive particle |
| [8] | Sorting-junction |
| [9] | Sorting-unit |
| [10] | Spacer-fluid junction |
| [11] | Spacer-fluid conduit |
| [12] | Upstream detection zone (zone 1) |
| [13] | Downstream detection zone (zone 2) |
| [14] | Sorting lane |
| [15] | Pair of sorting lanes |
| [16] | Pair of sorting lanes |
| [17] | Push-fluid inlet |
| [18] | Spacer-fluid inlet |
| [19] | Particle sample inlet |
| [20] | Sorted positive particles outlet |
| [21] | Waste (negative particles) outlet |
| [22] | Filter |
| [23] | Short detection loop |
| [24] | Long detection loop |
| [25] | Cartridge, isometric view |
| [26] | Push-fluid supply well or container |
| [27] | Space fluid supply well or container |
| [28] | Particle sample supply well or container |
| [29] | Sorted positive particle collection well or container |
| [30] | Waste collection well or container |
| [31] | Attachment feature for attachment of gasket |
| [32] | Alignment feature |
| [33] | Microfluidic section |
| [34] | Extra loop on the sample feeding conduit |
| [35] | Particle |
| [36] | Push-fluid conduit junction |
| [37] | Three-way valve |
| [38] | Time stamp |
| [100] | Sectioned view showing part of the manifold and cartridge |
| | support tray |
| [101] | Connector to electrical system |
| [102] | Attachment, attaching the manifold to the clamping system |
| [103] | 3/2 valve |
| [104] | pressure supply conduit (reservoir) |
| [105] | pressure supply conduit (reservoir) |
| [106] | Manifold |
| [107] | pressure supply conduit. |
| [108] | Cartridge support tray |
| [200] | A perspective view of the manifold and the cartridge |
| | support tray with a cartridge incl a gasket inserted |
| [201] | Sorting cartridge |
| [202] | Gasket |
| [203] | Attachment point for clamping motor |
| [204] | Guide for cartridge |
| [205] | alignment pin. It fit into a hole of the manifold when the |
| | manifold is closed. |
| [300] | Sectioned view showing part of the manifold and cartridge |
| | support tray with an inserted cartridge. |
| [400] | side view of the manifold and the cartridge support tray with a |
| | cartridge including a gasket. |
| [402] | Alignment springs. They help the cartridge go into place in the |
| | drawer, so the positioning of the cartridge is more fixed. |
| [500] | Sketch of the pneumatic system |
| [501] | Exhaust silencer |
| [502] | Pressure in valve |
| [503] | Pressure release valve |
| [504] | Exhaust valve |
| [505] | Vacuum or negative pressure valve |
| [601] | filter |
| [602] | pump |
| [603] | valve |
| [604] | Pressure sensor/switch |
| [605] | Pressure air vessel |
| [606] | Pressure regulator |
| [607] | Positive pressure regulation |
| [608] | Push buffer pneumatics |
| [609] | 3/2 direction valve |
| [610] | High pressure adjustment |
| [611] | Low pressure adjustment |
| [612] | Spacer buffer pneumatics |
| [613] | Droplet buffer pneumatics |
| [614] | Vacuum pump |
| [615] | Vacuum vessel |
| [616] | Vacuum adjustment |
| [617] | Sorter (vacuum) |
| [618] | Waste (vacuum) |
| [800] | Sketch of the optical system that forms 2 detection-zones. |
| [801] | Detection-zone 1 |
| [802] | Detection-zone 2 |
| [1200] | Cross sectional view of the manifold, the cartridge support tray |
| | and the optical head. In open position. |
| [1201] | Optical head |
| [1202] | Collection lens |
| [1203] | Longpass detector filter and lens system (Longpass allows long- |
| | waved light, approximately 515 nm and more to pass) |
| [1204] | Detector |
| [1205] | laser-light supplying light guide |
| [1206] | Line-generating lens system and shortpass filter (Shortpass |
| | allows shortwaved light approximately 488 nm and shorter to |
| | pass) |
| [1207] | Actuator, one of three actuators used to align the optic head |
| | relative to a cartridge inserted into the instrument. |
| [1208] | Part of the drawer-mechanism used to place the cartridge inside |
| | the instrument. |
| [1300] | Cross sectional view of the manifold the cartridge support tray |
| | with a Single Emulsion cartridge incl a gasket inserted. |
| [1301] | Single Emulsion cartridge holder |
| [1302] | Single Emulsion cartridge |
| [1400] | A perspective view of the alignment mechanism showing the 3 |
| | actuators. Mechanism seen from below. 6 |
| [1401] | Optical head support plate |
| [1402] | Motor operating the drawer mechanism |
| [1501] | Touch screen |
| [1502] | Start button |
| [1503] | Drawer mechanism |
| [1504] | Door |

### The Invention Presented in the Form of Embodiments

Preferred aspects and embodiments of the invention may be presented as items of the specification. These are given below.

1. A system for sorting of particles in a liquid medium comprising:
a cartridge comprising at least one microfluidic sorting-unit wherein a unit comprises (i) at least one sample feeding conduit for feeding a sample fluid to a sorting-junction wherein the sample fluid comprises a mixture of positive and negative particles to be sorted [1], (ii) at least one microfluidic sorted positive particles conduit for removing a fluid comprising positive particles from the sorting-junction [4], and (iii) at least one microfluidic waste conduit for removing a waste fluid comprising negative particles from the sorting-junction [5], said unit characterized in that the at least three microfluidic conduits (i), (ii) and (iii) meet at the sorting-junction,
said cartridge further comprising at least one detection zone for detecting a positive particle in the sample feeding conduit (i) upstream the sorting-junction, and
an instrument which controls the flow of fluids through the at least one microfluidic sorting-unit and which regulates the flow rate of particles in the sample feeding conduit in response to detecting a positive particle in the feeding conduit upstream of the sorting-junction.

2. The system according to item 1, wherein the at least one microfluidic sorting-unit [9] further comprises (iv) at least one push-fluid conduit [3] for feeding push-fluid to the sorting-junction, said unit characterized in that at least four microfluidic conduits meet at the sorting-junction [2].

3. The system according to item 1 or 2, wherein the at least one microfluidic sorting-unit [9] further comprises (v) a spacer-fluid conduit [11] and a spacer-fluid junction [10] placed upstream of the sorting-junction [2] in the sample feeding conduit [1] for feeding a spacer-fluid into the sample fluid comprising the particles to be sorted.

4. The system according to item 3, which comprises at least two separate detection zones, wherein an upstream detection zone [12] is placed upstream of the spacer-fluid junction [10] for detecting droplets before they reach the spacer-fluid junction [10], and wherein a downstream detection zone [13] is placed downstream of the spacer-fluid inlet for detecting positive droplets before they enter the sorting-junction [2].

5. The system according to any of the preceding items, wherein the cartridge is removable from the instrument.

6. The system according to any of the preceding items, wherein the cartridge comprises a set of wells or containers for fluids that can contain all volumes of fluids needed to accomplish the sorting including the sample fluid, the waste fluid, and the sorted positive particles fluid.

7. The system according to any of items 3-6, comprising means for inducing a sorting event by invoking pneumatic force on a spacer-fluid inlet [18] in response to the detection of a positive particle upstream of the sorting-junction.

8. The system according to any of the preceding items, comprising means for reducing the flow rate of particles in the sample feeding conduit temporarily for 1 second or less after the detection of a positive particle upstream of the sorting-junction.

9. The system according to any of the preceding items, wherein the instrument comprises an optical detector for identifying at least one optical signal characteristic of positive particles in the at least one detection zone of the cartridge.

10. The system according to item 9, wherein the at least one detection zone comprises a fluorescence detector for identifying at least one fluorescence signal characteristic of positive particles.

11. The system according to item 9 or 10, wherein the at least one detection zone comprises a fluorescence detector for identifying a laser-induced fluorescent signal characteristic of positive particles.

12. The system according to any of the preceding items, wherein the at least one detection zone comprises a laser and a fluorescence detector for detecting positive particles.

13. The system according to any of the preceding items, wherein the particles are droplets.

14. The system according to any of the preceding items, wherein the particles are double emulsion droplets.

15. The system according to any of the preceding items, wherein both the push-fluid and the spacer-fluid are aqueous fluids.

16. The system according to any of the preceding items, comprising means for supplying the push-fluid at a variable, positive pressure.

17. The system according to any of the preceding items, comprising means for supplying the spacer-fluid at a variable, positive pressure.

18. The system according to any of the preceding items, comprising means for applying a variable, negative pressure to the sorted positive particle conduit [4] and the waste conduit [5].

19. The system according to any of the preceding items, wherein the sorting-unit is an integral part of a sorting lane [15].

20. The system according to any of the preceding items, wherein the cartridge is removable from the instrument and adapted for single use.

21. The system according to any of the preceding items, wherein the cartridge comprises two or more sorting lanes.

22. The system according to item 21, and wherein the two or more sorting lanes are organized in pairs.

23. The system according to item 21 or 22, wherein the at least one detection zone comprises parts of at least two separate particle feeding conduits of a sorting lane pair.

24. The system according to any of items 21 to 23, wherein each pair of sorting lanes comprises an upstream detection zone [12] and a downstream detection zone [13].

25. The system according to any of items 21 to 24, wherein the instrument detects signals from two separate sample feeding conduits of a sorting lane pair, wherein each of the two sample feeding conduits comprises a detection loop.

26. The system according to item 25, wherein the two detection loops are of different lengths.

27. The system according to any of the preceding items, wherein the downstream detection zone is designed to allow the instrument to detect whether a correct sorting has occurred.

28. The system according to any of items 21 to 27, wherein the two or more sorting lanes are at least substantially parallel.

29. The system according to any of items 21 to 28, wherein the two or more sorting lanes are pneumatically connected to the same pressure supply.

30. The system according to any of the preceding items, wherein the instrument, in addition to being designed to fit the cartridge, control and drive the fluids through the cartridge also is designed to fit, control and drive the fluids through a cartridge made to produce single emulsion droplets as well as a cartridge made to produce double emulsion droplets.

31. The system according to any of items 13-30, wherein the droplets to be sorted do not contain cells.

32. A cartridge comprising at least one microfluidic sorting-unit as defined in any of the preceding items.

33. The cartridge according to item 32, wherein the cartridge comprises a set of wells or containers for fluids that can contain all volumes of fluids needed to accomplish the sorting including the sample fluid, the waste fluid, and the sorted positive particles fluid.

34. The cartridge according to any of item 32 or 33, wherein the cartridge comprises at least eight sorting lanes organized in four pairs.

35. The cartridge according to any of items 32-34, wherein the well or container collecting the sorted positive particles has a bottom part having an inclining surface and wherein the orifice of the collection well or container is provided at the lowermost part of said collection well or container.

36. The cartridge according to any of items 32-35, wherein the conduits meeting at the sorting-junction [8] have a width of 100 μm or less and a depth of 100 μm or less.

37. The cartridge according to any of items 32-36, wherein the inlets of the wells or containers for at least the push-fluid, the spacer-fluid, and the suspended particle fluid comprise a pillar filter particularly having a distance between the perimeter of each pillar of 15 to 100 μm.

38. The cartridge according to any of any of items 32-37, wherein the cartridge is designed asymmetrically to ensure correct insertion into the instrument.

39. An instrument which is part of a system according to any of items 1-31.

40. The instrument according to item 39, wherein the instrument comprises an optical head which forms an integrated unit comprising an optical system that forms 2 linear detection zones, the upstream and the downstream detection zones, said optical head further comprise the optics and the detectors needed for detection of positive particles.

41. The instrument according to item 40, wherein positive particles are detected by a laser-induced fluorescent signal.

42. The instrument according to item 41, wherein the fluorescent signal emitted from positive particles both in the upstream and the downstream detection zones are collected through one single lens-system.

43. The instrument according to any of items 39-42, wherein the instrument comprises an alignment system which align the cartridge with the optical system.

44. The instrument according to item 43, wherein the alignment system comprises 3 actuators which align the optical system and the cartridge by moving the optical head in the X-Y plane.

45. The instrument according to item 44, wherein the alignment system automatically aligns the optical head and the cartridge.

46. The instrument according to any of items 39-45, wherein the instrument controls the flow of fluids through the at least one microfluidic sorting-unit by a pneumatic system which operates with both variable, positive and with variable, negative pressures.

47. The instrument according to item 46, wherein the pneumatic system comprises a set of directional control valves which are able to feed the microfluidic system with high positive pressure or low positive pressure, and a different set of directional control valves which are able to feed the microfluidic system with variable negative pressure or with ambient pressure.

48. A method for sorting of particles comprising the use of the system according to any of items 1 to 30 and comprising the steps of:
i. providing a sample fluid comprising particles,
ii. providing a microfluidic cartridge according to any of items 32-38 comprising a supply well or container comprising a volume of push-fluid, a supply well or container comprising a volume of spacer-fluid and a supply well or container comprising a volume of the particle sample fluid,
iii. inserting the cartridge into the instrument according to any of items 39-47,

iv. starting the sorting on the instrument, and

v. after the sorting is complete, transferring the sorted positive particles into a suitable container, and discarding the cartridge.

49. The method according to item 48, wherein the particles are cells including eukaryotic ells, e.g., mammalian cells.

50. The method according to item 48 or 49, wherein the sample fluid comprises a single-cell suspension, e.g., a suspension of non-encapsulated cells.

51. The method according to any of items 48-50, wherein the particles are cells encapsulated in droplets.

52. The method according to any of items 48-51, wherein the particles are double-emulsion droplets.

53. The method according to any of items 48-52, wherein the flow rate of particles is temporarily decreased in response to a positive signal detected by the instrument at the upstream detection zone [12] of the cartridge.

54. The method according to any of items 48-53, wherein a spacer-fluid is fed through a spacer-fluid junction into the sample feeding conduit.

55. The method according to any of items 48-54, wherein negative carrier particles are added to any well of the cartridge.

56. An in-vitro method for enriching one or more target nucleic acid molecules from a sample of mixed nucleic acid molecules comprising the steps of:
i. providing a liquid sample of mixed nucleic molecules comprising at least one or more specific target nucleic acid molecule and at least one reagent for a specific detection of at least one of said target nucleic acid molecules,
ii. forming an emulsion comprising a plurality of double-emulsion liquid droplets each comprising mixed nucleic acid molecules from said liquid sample,
iii. incubating the emulsion liquid droplets to obtain a specific detectable reaction in droplets containing at least one specific target nucleic acid molecule,
iv. loading the reacted droplets into the system for sorting droplets according to any of items 1 to 30,
v. sorting the microdroplets by use of the system,
vi. collecting the sorted droplets in a suitable container, coalescing the sorted droplets, and
vii. subjecting the coalesced selected droplets from step vi to a general amplification procedure.

57. The method according to item 56, wherein the at least one target nucleic acid molecule is a target DNA molecule.

58. The method according to item 56 or 57, wherein the at least one reagent for a specific detection is a PCR reagent and the specific detection of said one or more target nucleic acid molecule is performed by PCR.

59. The method according to any one of items 56-58, wherein the general amplification procedure in step (vii) is performed by multiple displacement amplification.

60. A kit of parts for carrying out any of the methods according to any of items 48-59, which comprises:
a) at least one cartridge according to any of items 32-38,
b) at least one gasket to fit the at least one cartridge to an instrument of a system for sorting of particles, particularly the system according to any of items 1-31, and
c) at least vial of buffer fluid in an amount sufficient to perform the number of sortings provided for by the at least one cartridge.

### EXAMPLES

### Example 1: Enrichment Using the Xdrop Sort-System

Preparation of Droplets with Beads

An initial aqueous sample was supplemented with 3 μl (Alignflow™ Flow Cytometry Alignment Beads for Blue Lasers, 2.5 μm, ThermoFisher) mixed into the sample reaction mixture. A sample of double emulsion droplets was created using Xdrop dPCR proprietary droplet production technology as described by Madsen et al., 2020 (Human mutation doi: 10.1002/humu.24063). dPCR droplets were produced on an Xdrop instrument (item #IN00100, Samplix ApS, Herlev, Denmark) using the double-emulsion generating cartridge (Samplix item #CA10100) and standard run parameters (production time of 40 minutes).

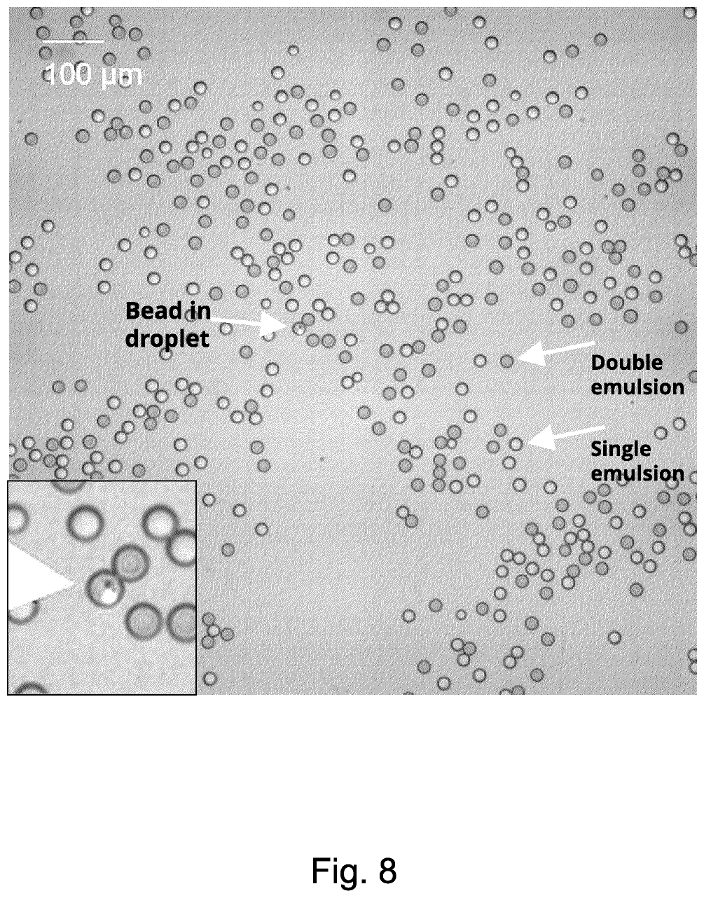

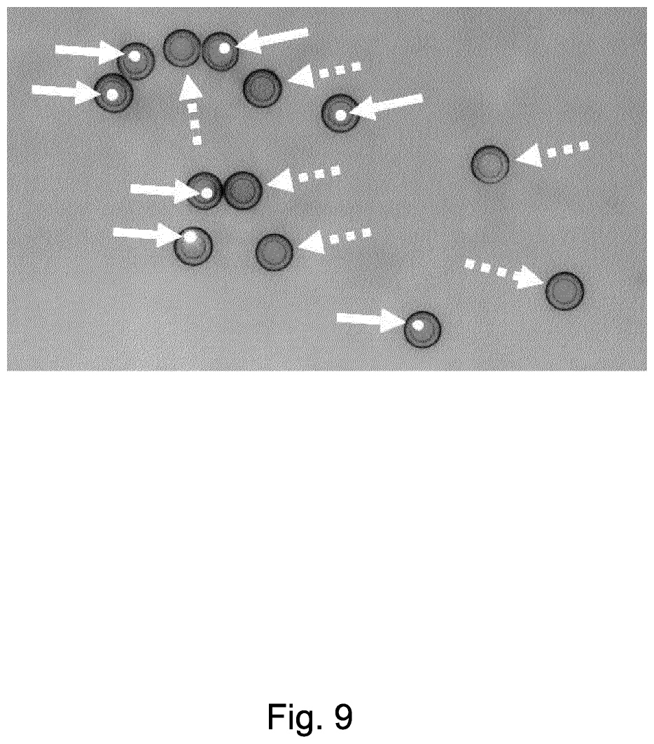

Following droplet production, the frequency of beads in droplets was quantified by FACS analysis. The frequency was determined to be 0.3% (FIG. 8). The droplet production resulted in an approximately 50:50 mixture of double emulsion droplets (Water-Oil-Water) and single emulsion droplets (Oil-Water). The produced droplets are shown in FIG. 8.

Sortinq

A total of 2725 positive droplets were sorted using the microfluidic device and an early version of the instrument which did not provide for alternating fluid speeds. Accordingly, sorting was processed only at slow speeds running at an average of 42 droplets pr. second. Total duration of sorting was 6 hours.

After sorting, the droplets were collected and sorting efficiency was calculated by comparing double emulsion droplets with beads to the total amount of double emulsion droplets. Purity of sample (the frequency of bead-positive droplets) after sorting was 53.8% (beads-in-droplets to total droplet counts).

Conclusion

At slow speed (approx. 42 droplets pr. second), sorting was carried out in a preliminary version of the system for a total duration of 6 hours. During that period, 2725 droplets were sorted and the purity after sorting was calculated to 53.8%. Starting from a frequency of 0.3% beads in droplets the enrichment was 180-fold, as a result of the sorting procedure.

### Example 2: The Sorting System can Sort Double Emulsion Droplets and Correct Sorting can be Quantified Using a Feedback Loop

In this example, it is demonstrated that the present invention (the Xdrop Sort system) can sort double emulsion droplets based on fluorescence into a 1/2

Materials and Methods.

Double emulsion droplets containing fluorescently stained DNA were produced using the method of Madsen et al., 2020 (Human Mutation doi: 10.1002/humu.24063). In addition, Metacresol purple was added to the droplet sample buffer (i.e. outer buffer containing the double emulsion) to be able to visualize the operation of the sort function in a bright field microscope.

Samplix dPCR buffer (Madsen et al., 2020) was used as both Push buffer and Spacer buffer.

The microfluidics chip, see FIGS. 2 and 3, contained a particle sample inlet [19] and a sample feeding conduit [1]; a spacer-fluid inlet [18] and a spacer-fluid conduit [11]; a push-fluid inlet [17] and a push-fluid conduit [3] Furthermore, the chip contained a sorted positive particles outlet [20] and a Positive particle conduit [4], a negative particle conduit (waste) [5] and a waste (negative particles) outlet [21]. The three inlets (the particle sample inlet [19], the spacer-fluid inlet [18], and the push-fluid inlet [17] were operatively connected to a pressure system consisting of six different positive pressures (0.1 barg to 5 barg). The two outlet conduits (sorted positive particles outlet [20], and the waste (or negative particles) outlet [21]) were operatively connected to a pressure system consisting of four ambient or negative pressures (−1 barg to 0 barg). Each inlet or outlet was arranged to receive two different pressures. Each inlet was pneumatically connected to an electronic 3/2-way valve [37]/[609] as shown in FIG. 13 and FIG. 28.

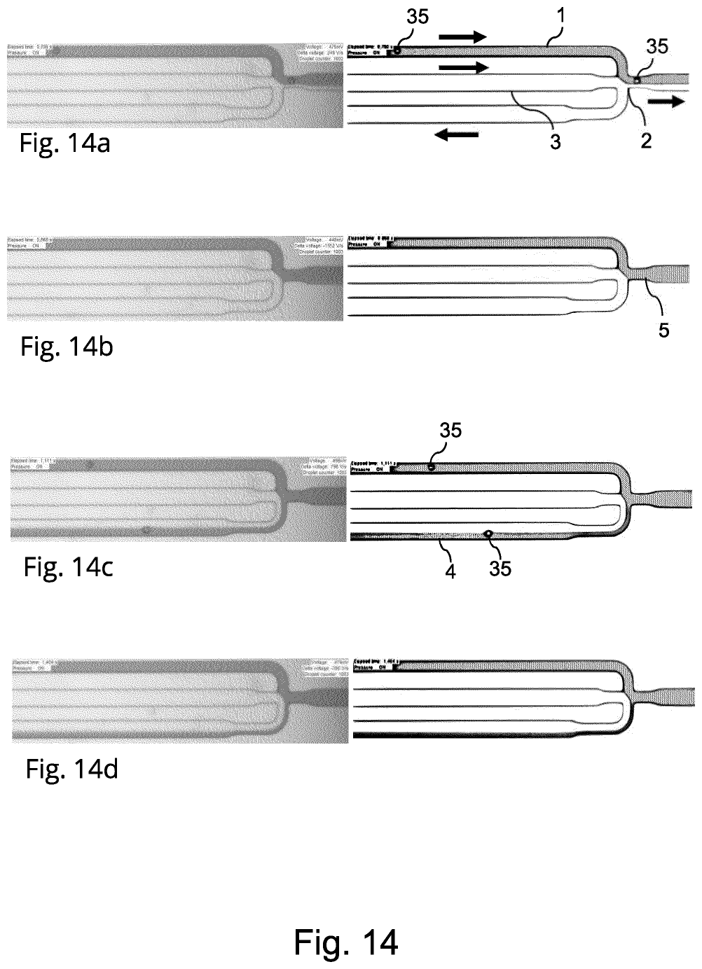

Two pressure regulators connected to the 3-way valve regulate the pressures in the connected reservoirs inserted between the pressure regulator and the valve, see FIGS. 13 and 28. Pressure to each inlet was regulated by valves receiving input based on the detection of a signal at the two detection zones. When a valve was activated or deactivated, pressure supply therefore changed from one pressure reservoir to another. Using valves rather than a direct contact to pressure regulators has the advantage that fewer pressure regulators are employed, as pressure regulators can be shared between more individual lines. Thereby the cost is reduced. In addition, valve response time can be made significantly shorter than the time needed for a pressure regulator to reach a new pressure. This is because the valves open immediately to the alternative pressure reservoir without needing to measure and adjust pressure. As can be seen from figure FIG. 14, single droplets were sorted, and pressures returned to “waste” settings in less than a second.

Note that the timestamps are: FIG. 14a 0,780 s; FIG. 14b 0,868 s; FIG. 14c 1,111s; and 14d 1,404 s, i.e. the whole cycle is made in 0,624 s.

Pressure on the push-fluid conduit [3] was set to allow a small part of the push-fluid into the waste stream which prevents droplets from entering the positive particle conduit (sorted droplets conduit) [4].

To allow sorting, the pressure on sorted positive particles outlet [20] was shifted to relatively low pressure and the pressure on negative particles outlet [21] was shifted to relatively high pressure. As the relative pressure now is lower in the positive particle conduit (sorted droplets) [4] relative to the pressure in the negative particle conduit (waste) [5], flow is allowed into the positive particle conduit [4].

The droplets in the sample feeding conduit [1] were analysed by illuminating the conduit with a laser line with peak intensity at 488 nm at the detection zones. The signal from the conduits was detected using a silicon photomultiplier with a 514.5±0.2 nm bandpass filter where the detector was directed to detect signal from a circular region overlapping the laser line. Both laser and detector were positioned below the microfluidic conduit. Positive droplets containing greater amounts of DNA than negative droplets emit more fluorescent light after being stained with an intercalating dye, and a higher signal is therefore detected. The presence of a signal above the threshold value triggered the valve connected to the negative particle conduit (waste) to shift from a pressure of around −150 mbarg to ambient pressure and simultaneously triggered the valve connected to the Positive particle conduit (sorted droplets conduit) to shift from ambient to a pressure around −150 mbarg. Positive pressure was maintained in the sample feeding conduit [1] and the push-fluid conduit [3]. After a short delay, the pressure on the negative particle conduit (waste conduit) [5] and the positive particle conduit (sorted droplets conduit) [4] was shifted back to “waste mode” by returning the valves to the “waste” positions. Droplets now resumed the flow into the negative particle conduit (waste conduit) [5]. The sorted positive droplet continued flowing forward in the Positive particle conduit (sorted droplets conduit) [4] to the sorted positive particles outlet [20] and the sorted positive particle collection well or container [29], as the push-fluid continues to supply a small amount of push-fluid into the Positive particle conduit (sorted droplets conduit) during “waste” mode.

The purity of the positive droplets (ratio of positive droplets to total droplets) before sorting was determined on a cell sorter to be 0.41% (out of 4.1 million total droplets). The droplets are a mixture of double emulsion droplets and oil droplets. In purity calculations, the oil droplets are not counted as they do not contain fluorescence.

Purity of positive sorted droplets was determined from comparison of fluorescence and bright field pictures. Oil droplets counts were also not included in purity calculations based on bright field picture analysis. For all detected droplets (100%), a dual peak (two consecutive peaks within a short time interval) was detected, indicating a 100% recovery of positive droplets above detection threshold. Table 1 shows the results of 16 individual sorting events, all with an initial purity of 0.41% before sorting.

TABLE 1
For each sorting event 1-16, it was recorded if an event was detected
twice (dual peak detected) indicating a successful sorting event
(illustrated on FIG. 14). Also, pictures from each sorting event
were analysed to observe how many droplets were sorted per positive
event (# of droplets sorted). As 50% of the droplets are pure
oil droplets that cannot contain the particle, 3 droplets sorted
corresponds to a purity of 1 positive/(1 negative + 1 positive) = 50%

| | Dual peak detected | # droplets per sort | Purity % |
|---|---|---|---|
| 1 | Yes | 3 | 50 |
| 2 | Yes | 3 | 50 |
| 3 | Yes | 2 | 67 |
| 4 | Yes | 2 | 67 |
| 5 | Yes | 3 | 50 |
| 6 | Yes | 4 | 40 |
| 7 | Yes | 3 | 50 |
| 8 | Yes | 4 | 40 |
| 9 | Yes | 2 | 67 |
| 10 | Yes | 4 | 40 |
| 11 | Yes | 4 | 40 |
| 12 | Yes | 2 | 67 |
| 13 | Yes | 2 | 67 |
| 14 | Yes | 3 | 50 |
| 15 | Yes | 1 | 100 |
| 16 | Yes | 2 | 67 |

### Example 3: The Detection Signal from Two Parallel Sorting Lines can be Distinguished by Observing the Delay Time in Conduit Loop Regions

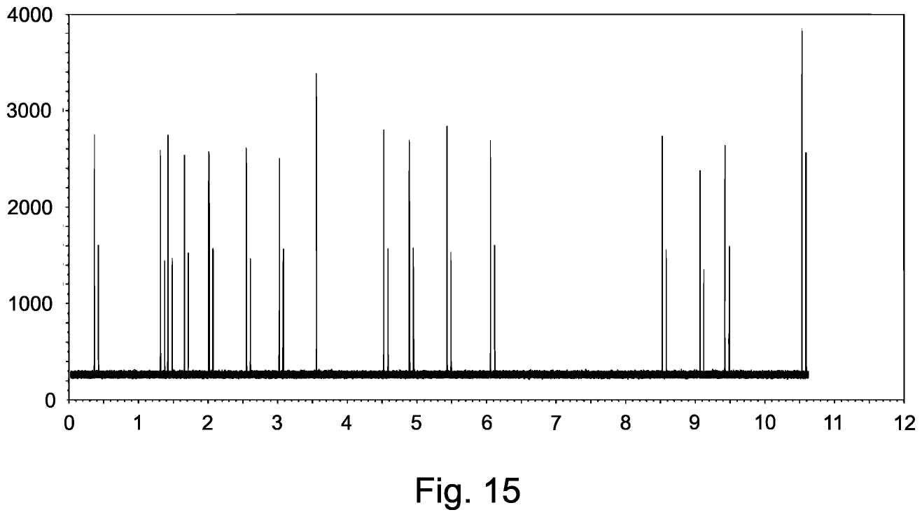

FIG. 15 show the detection signals obtained from positive droplets passing the downstream detection zone [13] and using a silicon photomultiplier. The figure shows the voltage output from the photomultiplier (PMT) as a function of time. Positive droplets passed the detection zone and fluorescence from the droplet was detected. In most events, a high peak was followed by a lower peak indicating that the droplet was correctly sorted and therefore re-entered the detection zone through the positive sort conduit. In one case, the droplet was not correctly sorted, and only one peak was therefore detected. Based on this information, the purity of the efficiency of the sorting could be estimated.

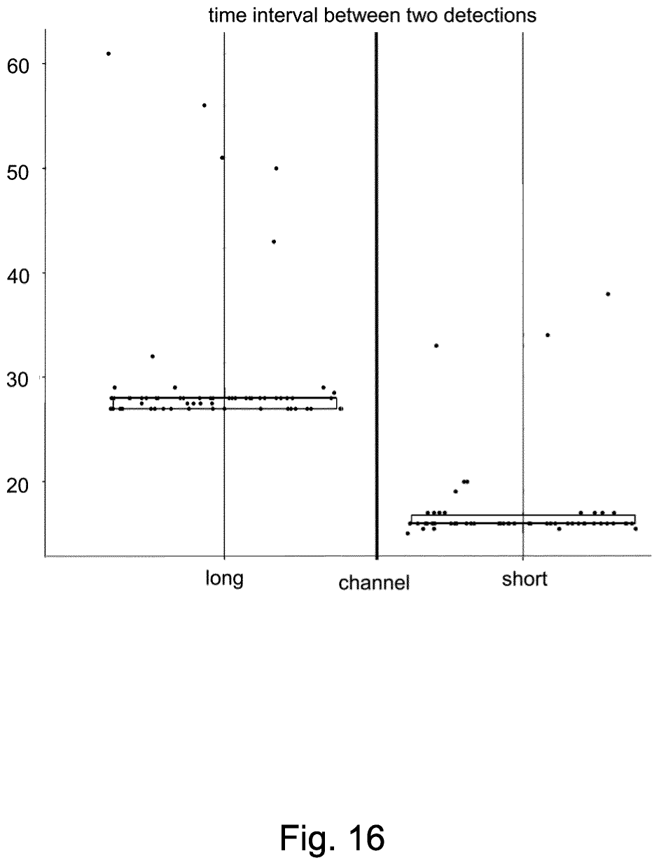

Lasers and detectors are expensive components and it is therefore an advantage to minimize the number of these components in the system. A microfluidic setup was therefore designed that enables the system to distinguish the signal from two different sorting lines by observing the delay of events from they pass through the upstream detection zone [12] the first time and until they re-enter the detection zone after passing through a loop, see FIG. 4. The loops of the two parallel lines have different lengths and the time of travel from first pass to second pass will therefore be different, see FIG. 4a. This can be observed as dual peaks from the detector with different time interval between the peaks, see FIGS. 4b and 4c. FIG. 16 shows the measured delay times from two lines with different loop length as shown in FIG. 4a. The time interval between dual peaks from the two conduits is clearly different (boxes indicate the 75% confidence intervals) and can be used to distinguish if a particle is passing through the first or the second line. In this test, droplets were passed through the upstream detection zone at a speed of more than 5000 droplets per second.

### Example 4. Changing Flow Velocity when a Droplet is Detected Makes it Possible to Achieve Faster Sorting

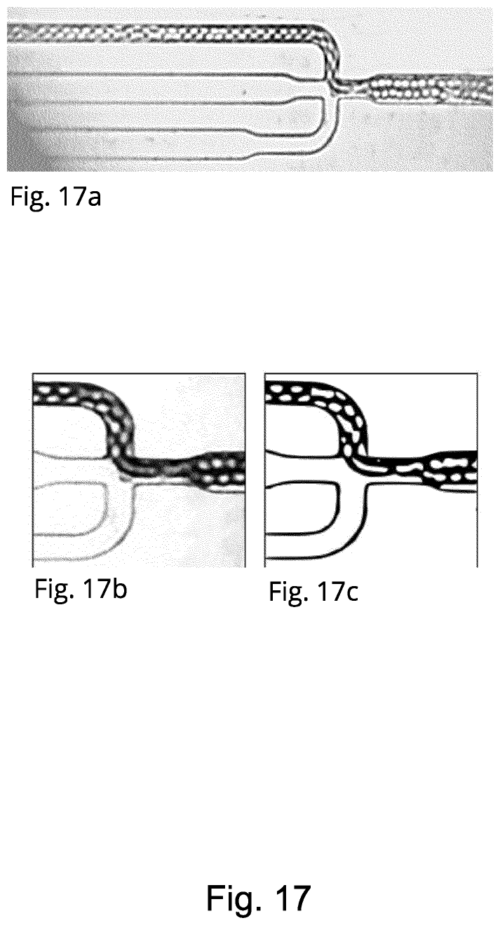

The droplet flow rate in the current system, where the sample feeding conduit [1] is connected to positive pressure on the inlet conduits and negative pressure on the outlet conduit, was determined at a pressure of 1950 mbarg in the droplet inlet conduit, 650 mbarg in the spacer conduit, 325 mbarg in the push buffer conduit, 0 mbarg in the positive sort conduit, and −140 mbarg in the waste conduit. At these pressure settings, a sample of 5 million droplets could be processed into the waste conduit in 16 minutes corresponding to a droplet flow rate of 5,200 droplets/second, showing the advantage of operating with both positive and negative pressures at the sorting-junction. See FIG. 17.

Another advantage of operating with both positive and negative pressure at the gate is that the flow rate of droplets can be regulated relative to the flow rate in the push buffer conduit. As there may be limited volumes in the inlet wells containing the droplets [28] and buffers [26] and [27], it is an advantage that the relative processed volume of the two liquids can be adjusted by adjusting the pressure on the two inlet conduits relative to each other.

### Example 5. Increasing Speed when No Positive Events are Detected Decreases Total Sorting Time

As described in example 4, flow-rates of up to 5,200 droplets per sec was obtained when no sorting was invoked and all droplets were passed to the negative particle conduit (waste) [5]. When a positive droplet is detected at the upstream detection zone [12], the droplet flow rate is lowered to obtain a high efficacy of the sorting. In response to the detection of a positive droplet at the upstream detection zone [12], the valve controlling pressure applied to the Sample feeding conduit [1] is temporarily switched to provide a lower pressure resulting in a rapid down-modulation of the droplet flow rate. Deceleration time was measured to be around 0.8 seconds. Acceleration time to revert to high droplet flow rate was estimated at 0.1 sec. The time necessary to sort a droplet was estimated to 0.1 second giving a total time of a sorting of around 1 second. Depending on the number of positive droplets in the sample and the number of total droplets, the two-speed system will give a significantly shorter total sort time as illustrated in table 2 below.

TABLE 2
Estimated time of sorting in two-speed sorting systems and one-speed
systems assuming a total sort time per droplet of 1 second in the
two-speed system, including deceleration and acceleration, and a
constant speed of 20 droplets per seconds in the one-speed system.
Two-speed system (1 mio droplets total)

| | Time at slow | | |
|---|---|---|---|
| Number of | speed (min) 1 | Time at high | Total sorting |
| positive droplets | sec per drop | speed (min) | time (min) |
| 100 | 1.7 | 3.3 | 5.0 |
| 1,000 | 16.7 | 3.3 | 20.0 |
| 10,000 | 167 | 3.3 | 170 |

| | | | |
|---|---|---|---|
| Number of | Time at slow | Time at high | Total sorting |
| positive droplets | speed (min) | speed (min) | time (min) |

Two-speed system (10 mio droplets total)

| | | | |
|---|---|---|---|
| 100 | 1.7 | 33.3 | 35.0 |
| 1,000 | 16.7 | 33.3 | 50.0 |
| 10,000 | 167 | 33.3 | 200 |

One-speed system (1 mio droplets total) at

| | | | |
|---|---|---|---|
| 100 | 833 | — | 833 |
| 1,000 | 833 | — | 833 |
| 10,000 | 833 | — | 833 |

One-speed system (10 mio droplets total)

| | | | |
|---|---|---|---|
| 100 | 8333 | — | 8333 |
| 1,000 | 8333 | — | 8333 |
| 10,000 | 8333 | — | 8333 |

### Example 6. The Instrument (Xdrop Sort) can Also Produce Single Emulsion and Double Emulsion Droplets

A double-emulsion droplet generating cartridge (item #CA10100, Samplix ApS, Herlev, Denmark) was loaded with sample, oil, and dPCR buffer in 6 out of 8 lines as described in Madsen et al., 2020. A gasket was positioned on top of the cartridge and the assembly was then inserted into the Instrument of the present invention (Xdrop Sort). When pressing start, the Xdrop Sort instrument supplied pressure to the 6×3 wells containing liquids. The liquids were then pushed through the microfluidic emulsion forming part of the double-emulsion droplet generating cartridge and double emulsions were produced.

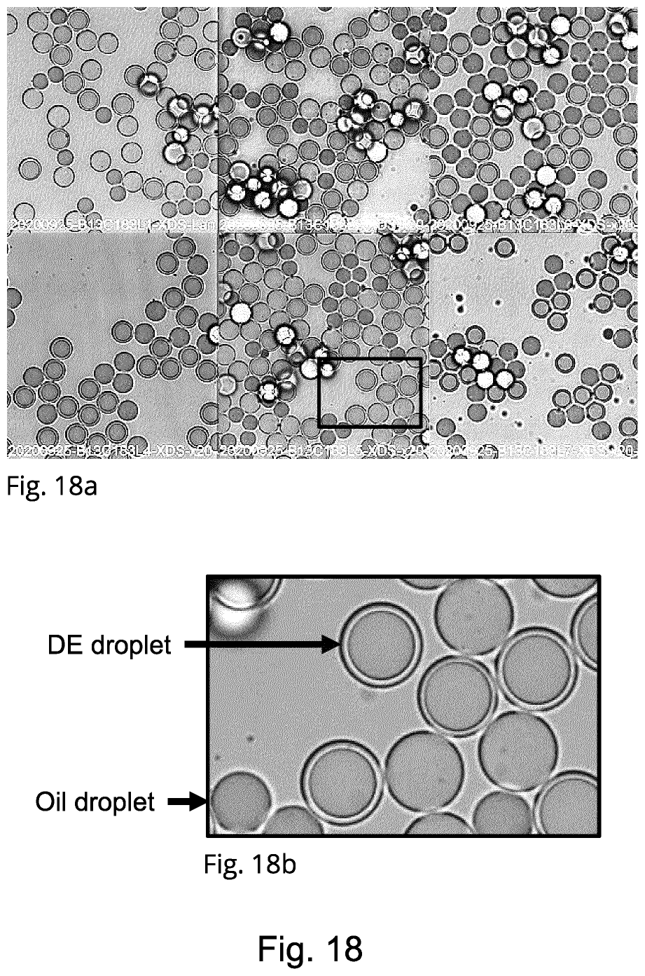

FIG. 18 shows the double emulsion droplets produced using the Xdrop Sort instrument in 6 out of 6 lines loaded.

A single-emulsion droplet generating cartridge (item #CA20100, Samplix ApS, Herlev, Denmark) was loaded with sample, oil, and dPCR buffer in 8 out of 8 lines as described in Madsen et al., 2020. A gasket was positioned on top of the cartridge and the assembly was then inserted into the Xdrop Sort instrument. When pressing start, the Xdrop Sort instrument supplied pressure to the 8 wells containing liquids. The liquids were then pushed through the microfluidics of the single-emulsion droplet generating cartridge and single emulsion droplets were produced.

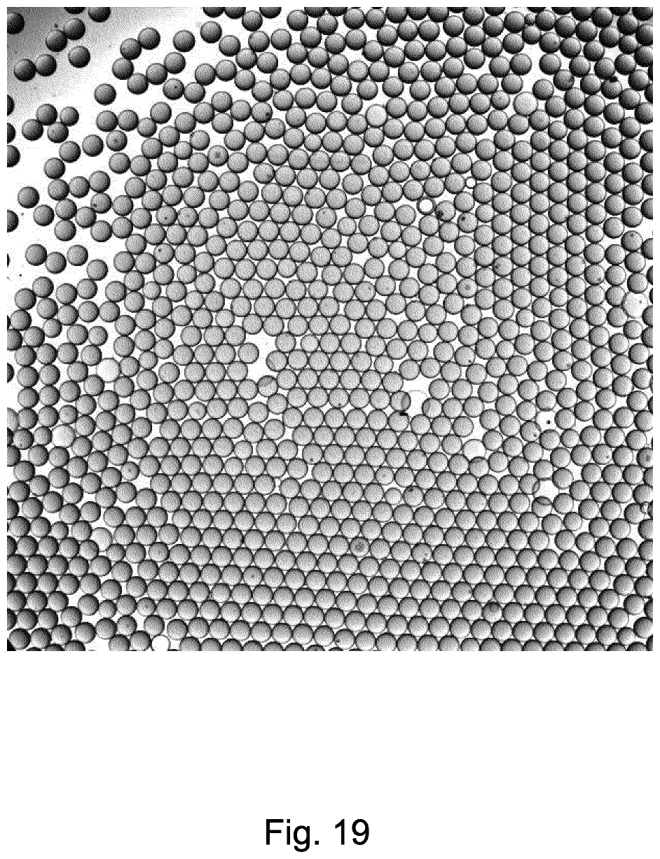

FIG. 19 shows one example of single emulsion droplets produced using the Xdrop Sort instrument.

### Example 7. The Push-Fluid Ensures that Positive Droplets are Transported Away from the Sorting-Junction

Double emulsion droplets containing fluorescently stained DNA was produced using the method of Madsen et al., 2020 (Human Mutation doi: 10.1002/humu.24063).

Samplix dPCR buffer (Madsen et al., 2020) was used as both push-fluid and spacer-fluid.

The microfluidics chip contained an inlet for Sample feeding conduit the particle sample inlet [19], a spacer-fluid inlet [18], a push-fluid inlet inlet [17], in addition to a sorted positive particles outlet [20], and a waste (negative particles) outlet [21] see FIG. 3.

The three inlets were operatively connected to a pressure system consisting of six different positive pressures (0.1 barg to 5 barg) and four ambient or negative pressures (−1 barg to 0 barg) via the corresponding wells, i.e. via the push-fluid supply well or container [26], the Space fluid supply well or container [27], the Particle sample supply well or container [28], the Sorted positive particle collection well or container [29], and the waste collection well or container [30].

Each inlet or outlet was arranged to receive two different levels of pressures as discussed in example 2.

Pressure on the push inlet was set to allow a small part of the push buffer into the waste stream which prevents droplets from entering the “sort” conduit.

To allow sorting, pressure on sorted positive particles outlet [20] was shifted to relative low pressure and the pressure on negative particles outlet [21] was shifted to relatively high. As the relative pressure now is lower in the positive particle conduit (sorted droplets) [4] relative to the pressure in the negative particle conduit (waste) [5], flow is allowed into the Positive particle conduit [4].

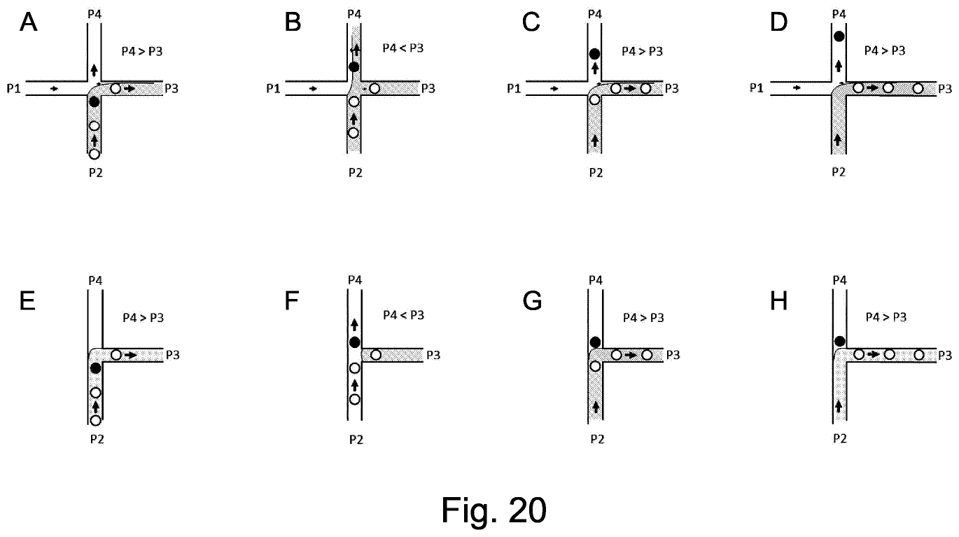

The function of sorting-units with or without a push-fluid conduit junction [36] at the junction point [2] is schematically illustrated in FIG. 20. The figure illustrates a situation wherein push-fluid is constantly flowed into the junction allowing sorted positive particles to travel further into the sorting lane—top line of figures. If, instead, a junction without a push buffer system is used, the sorted positive particles will stay at the gate (junction point of the positive particle conduit). This significantly increases the risk of the sorted positive particles being drawn back into the waste stream, see lower line of figures (FIG. 20 E-H).

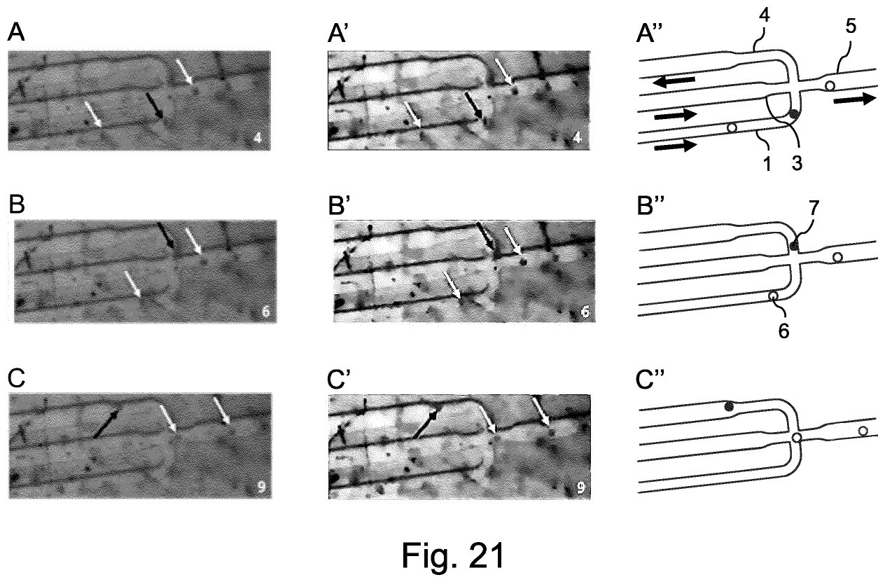

FIG. 21 illustrate a real time sorting of a positive droplet in a sorting-unit according to the invention which comprise a junction point with a push-fluid conduit junction. The figure shows how the positive droplet continues the travel into the sorting lane even after droplets resume flow into the waste conduit. Upper and lower panels are identical except for droplets being coloured solid white and black in the lower panel. Pictures are taken at time intervals of 6 ms.

### Example 8. Change of Speed and Addition of Space Buffer can be Achieved in Less than a Second

To achieve a fast, overall sorting time, it is essential that shifts from high to low speed and from low to high speed can be achieved in a short time. To demonstrate fast flow rate shifts a system as described in example 7 was employed.

Droplets were passed through the feeding conduit at approximately 5000 droplets per second. In response to the detection of a positive particle at the upstream detection zone pressures were shifted from a relatively high to a relatively low pressure on sorted positive particles outlet [20] and, at the same time, the pressure on the spacer-fluid outlet from a relatively low level to a relatively high level, see table 4 for example of pressures. The result is a rapid spacing of the particles in the downstream parts of the Sample feeding conduit as illustrated in panel A and B of FIG. 22. Panel A is time-stamped 1,135 s and panel B is time-stamped 2,003 s. Because of the time-stamping it was possible to see exactly when droplet flow rate had reached the slow value of 18 droplets per second.

To demonstrate the speed of short time of flow rate increase, pressures were restored to fast flow operation by shifting from a relatively low to a relatively high pressure on sorted positive particles outlet and, at the same time, shifting the pressure on the spacer-fluid outlet from relatively high to relatively low. This results in higher overall flow rate in the feeding conduit and lower flow rate in the spacer conduit. Panel C FIG. 22 is time-stamped 4,655 s and panel D is time-stamped 4,770 s.

Table 3 summarizes the results of the speed changes.

TABLE 3
Droplet flow rates during a sorting cycle.

| | Time stamps | |
|---|---|---|
| | on FIG. 22 | Droplet flow rate |
| Before pressure switching fast to | 1.135 sec | 5000 droplets per |
| slow | | second |
| After pressure switching fast to | 2.003 sec | 18 droplets per |
| slow | | second |
| Time difference | 0.868 sec | |
| Before pressure switching fast to | 4.655 sec | 18 droplets per |
| slow | | second |
| Before pressure switching fast to | 4.770 sec | 5000 droplets per |
| slow | | second |
| Time difference | 0.015 sec | |

TABLE 4
Example of pressures

| | Pressure, push | Pressure, spacer | Pressure, | Pressure, | Pressure, |
|---|---|---|---|---|---|
| | buffer inlet | buffer inlet | sample inlet | sort outlet | waste outlet |
| Before pressure | 400 mbarg | 400 mbarg | 1000 mbarg | 0 | −250 mbarg |
| switching | | | | | |
| fast to slow | | | | | |
| After pressure | 50 mbarg | 30 mbarg | 55 mbarg | 0 | −250 mbarg |
| switching | | | | | |
| fast to slow | | | | | |
| Delay | 200 ms | | | | |
| After pressure | 50 mbarg | 30 mbarg | 55 mbarg | −250 mbarg | 0 |
| switching | | | | | |
| slow to sort | | | | | |
| After pressure | 400 mbarg | 400 mbarg | 1000 mbarg | 0 | −250 mbarg |
| switching | | | | | |
| sort to fast | | | | | |

### Example 9: Enrichment Using the Xdrop Sort-System

Preparation of Droplets

8 samples of double emulsion droplets were created using Xdrop dPCR proprietary droplet production technology as described by Madsen et al., 2020 (Human mutation doi: 10.1002/humu.24063). Double emulsion droplets were produced on an embodiment of the instrument according to the current invention, the Xdrop Sort instrument, using the double-emulsion generating cartridge (Samplix item #CA10100) and standard run parameters (production time of 40 minutes).

In brief, 40 μL of each of the 8 samples containing PCR reagents and enzyme, 0.2 μM PCR forward primer (TP53_D_F1) and 0.2 μM PCR reverse primer (TP53_D_R3) both directed to human TP53, and 10 ng human genomic DNA was loaded into the sample well of the cartridge, oil was loaded into the oil well, and an outer aqueous buffer was loaded into the buffer well. The cartridge was inserted into the Xdrop Sort instrument and the droplet production was started from the instrument screen using the double emulsion production program. The Xdrop Sort instrument then added positive pressure to the 8 lanes thereby the three liquids into the microfluidic structure under the cartridge generating 8-10 million double emulsion droplets per lane. The droplets were collected from the exit well of the double emulsion droplet generation cartridge and transferred to PCR tubes. The emulsion samples were PCR cycled with the following program: 1×[94° C., 2 min], 40×[(94° C., 3 sec), (60° C., 30 sec)].

TP53_D_F1:
(SEQ ID NO: 1)
GGTGTGATGGGATGGATAAA
TP53_D_R3:
(SEQ ID NO: 2)
CCCTGCATTTCTTTTGTTTG

Following droplet production, the frequency of droplets with positive TP53 PCR reaction was quantified by FACS analysis. The frequency was determined to be around 0.01%. The droplet production resulted in an approximately 50:50 mixture of double emulsion droplets (Water-Oil-Water) and single emulsion droplets (Oil-Water).

Sortinq

200 μL double emulsion droplets were fluorescently stained by adding them to a 1 mL solution of outer buffer for droplet production containing 40 μL SYTO24 dye (Thermo Fisher Scientific) and incubating them in the dark for 5 minutes.

An 8-sample sorting cartridge was prepared for sorting of two parallel samples by loading 2 μL of fluorocarbon oil-in-water droplets (16 μm diameter) to the exit well ([29] FIG. 7). These droplets improve recovery of sorted double emulsion droplets by filling voids and surfaces in the cartridge. Then 600 μL and 300 μL outer double emulsion droplet buffer was added to the corresponding input wells on the Sort cartridge. The procedure was repeated for the second sample. Finally, 200 μL double emulsion samples were added to the particle sample supply well ([28] FIG. 7). Unused lanes were covered by a thin cover film. The cartridge was covered by a rubber gasket [202] made to ensure a pressure tight contact between the cartridge and the instrument while still allowing pressure connection between individual wells of the cartridge and the instrument through dedicated holes in the gasket. The sorting was initiated from the instrument screen by pressing the Sort button. The pressures and lasers settings were the following:

Instrument and Software Version:

| | |
|---|---|
| RUN_ID | 948 |
| Cartridge ID | Beta 99 |
| Lanes selected at startup | 3 + 5 |
| lane selected on tough screen [1501] | 3 + 5 |
| Software version | 0.2.24 |
| Instrument ID | P1 |
| FPGA* version | 24 |

*Field Programmable Gate Array

Laser power and pressures^{§}:

| | |
|---|---|
| Effect of laser, feeding upstream detection zone, DZ1 (mW) | 35 |
| Effect of laser, feeding downstream detection zone, DZ2 (mW) | 35 |
| HIGH P1 (mbarg) High droplet buffer pressure [613] | 1600 |
| HIGH P2 (mbarg) High space buffer pressure [612] | 700 |
| HIGH P3 (mbarg) High push buffer pressure [608] | 700 |
| LOW P1 (mbarg) Low droplet buffer pressure [613] | 300 |
| LOW P2 (mbarg) Low space buffer pressure [612] | 300 |
| LOW P3 (mbarg) Low push buffer pressure [608] | 150 |
| Sort Vac (P) (mbarg) sorter vacuum [617] | −300 |
| Waste (P) (mbarg) waste vacuum [618] | −150 |

^{§}see also FIG. 6x

The instrument settings set the limits for when an event in considered a true positive event (positive droplet) and determine the delays from detection in detection zone 1 (upstream detection zone) and detection zone 2 (downstream detection zone) to valve response.

The thresholds were adjusted from the instrument touch screen [1501] and the sorting now proceeded automatically for one hour, sorting a total of 8-10 million droplets for each lane. The instrument counted 678 and 1022 positive sorted droplets respectively.

Droplets were recovered from the cartridge after sorting and the recovered emulsion was de-emulsified (coalesced) by adding a break solution and the aqueous phase containing enriched TP53 region DNA was used for MDA amplification and qPCR quantification of enrichment as described in Madsen et al., 2020 (Human mutation doi: 10.1002/humu.24063). Enrichments of 120 fold and 258 fold were achieved for the two samples respectively.

A small part of the sample was inspected by microscope and confirmed the correct recovery of positive droplets.

### Example 10: Sorting of Mammalian Cells Using the XdropSort System

This example show that the system can sort cells, suspended as a single cell suspension, which not are encapsulated in droplets.

Methods:

Ramos B-cells were cultivated in media (RPMI-1640 with 20% HI FBS) until they reached a cell density of 1×10⁶ cells/mL. 15×10⁶ cells were strained through a 20 μm cell strainer, then centrifuged at 300×g for 10 min. The supernatant was removed, and cells were resuspended in 320 μl XdropSorting buffer. 100.000 cells (20 μl) were aliquoted from these suspensions and added 180 μl media and 20 μl CalceinAM stain (40 nM). The cells with stain were kept at 37° C., 5% CO₂ for 30 min, and afterwards the leftover stain was removed by washing the cells with 1 ml media, centrifuged at 300×g for 10 min, and resuspended in 1 ml XdropSorting buffer. Stained cells were mixed at a ratio of ˜1:10,000 with non-stained cells.

The XdropSort cartridge was loaded by adding 2 μL blank droplets to the positive droplet well, 600 μL of sorting buffer to the Push-fluid supply well [26] and 300 μL of sorting buffer to Space fluid supply well [27]. Finally, 150 μL cell suspension was added to the Particle sample supply well [28]. The instrument was initiated, and the threshold was adjusted on-screen to allow a response to cells but not to background in both detection zone 1 and detection zone 2. From instrument readouts, it could be seen that the instrument switched the corresponding valves correctly as a response to detection. The instrument showed that 42 positive events were sorted into the positive droplet well. The content of the positive droplet well was collected with a pipette and transferred to a microscope slide.

Results:

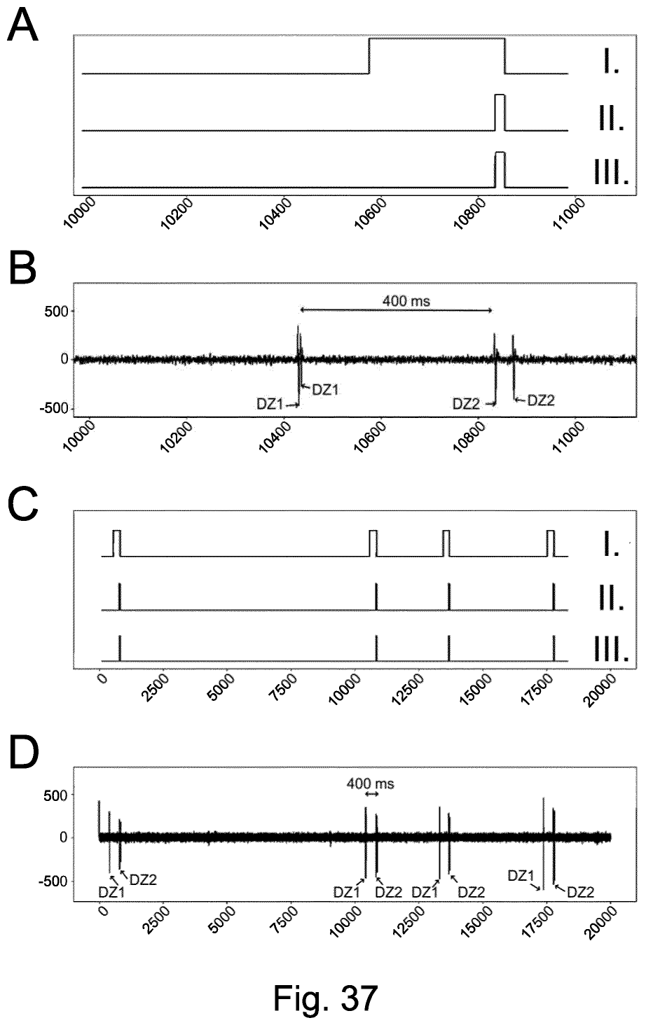

FIG. 37 shows an example of the signals registered by the instrument during a sorting cycle.

Panels B and D depict the signal generated by the cells at the detection zone 1 and 2, respectively. Panels A and C indicate the corresponding valve stages.

First, the cell entered the upstream detection zone 1 (DZ1) and a signal was recorded by the instrument (double peak in DZ1 signal). After a defined delay, the pressure valves were switched from high screening pressure to low sorting pressures (the line goes up). At this point, the instrument was waiting to receive a signal from downstream detection zone 2 (DZ2). When the cell arrived at DZ2, a signal was recorded which triggered the activation of the sort (II.) and waste (III.) so that the cell was pulled out of the flow into the positive sorted channel. Because of the design of the channel, the cell travelled a second time through DZ2 which was recorded (second DZ2 peak). This second signal is a verification of successful sorting event.

After activation of the sort and waste valves, the sorting cycle was completed, and the instrument returned to its screening mode with the high pressures (line I, II and III go down) to search for the next positive event.

In the microscope, approximately 1 fluorescent cell was observed per 30 non-fluorescent cells. As the concentration of stained cells in the sample was 1:10,000 this indicates a successful sorting with an enrichment of stained cells of around 330-fold.

1-31. (canceled)

32. A system for sorting of particles in a liquid medium comprising:
a cartridge comprising at least one microfluidic sorting-unit wherein the unit comprises (i) at least one sample feeding conduit for feeding a sample fluid to a sorting-junction wherein the sample fluid comprises a mixture of positive and negative particles to be sorted [1], (ii) at least one microfluidic sorted positive particles conduit for removing a fluid comprising positive particles from the sorting-junction [4], (iii) at least one microfluidic waste conduit for removing a waste fluid comprising negative particles from the sorting-junction [5], and (iv) at least one push-fluid conduit [3] for feeding push-fluid to the sorting-junction, said sorting-unit is characterized in that at least four microfluidic conduits (i), (ii), (iii) and (iv) meet at the sorting-junction [2],
said cartridge further comprising at least one detection zone for detecting a positive particle in the sample feeding conduit (i) upstream the sorting-junction, and
an instrument which controls the flow of fluids through the at least one microfluidic sorting-unit and which temporarily reduces the flow rate of particles in the sample feeding conduit in response to detecting a positive particle in the feeding conduit upstream of the sorting-junction,
wherein the particles are double-emulsion droplets.

33. The system according to claim 32, wherein the at least one microfluidic sorting-unit [9] further comprises (v) a spacer-fluid conduit [11] and a spacer-fluid junction [10] placed upstream of the sorting-junction [2] in the sample feeding conduit [1] for feeding a spacer-fluid into the sample fluid comprising the particles to be sorted.

34. The system according to claim 33, comprising at least two separate detection zones, wherein an upstream detection zone [12] is placed upstream of the spacer-fluid junction [10] for detecting particles before they reach the spacer-fluid junction [10], and wherein a downstream detection zone [13] is placed downstream of the spacer-fluid inlet for detecting positive particles before they enter the sorting-junction [2].

35. The system according to claim 32, wherein the cartridge comprises a set of wells or containers for fluids that can contain all volumes of fluids needed to accomplish the sorting including the sample fluid, the waste fluid, and the sorted positive particles fluid.

36. The system according to claim 33, comprising means for inducing a sorting event by invoking pneumatic force on a spacer-fluid inlet [18] in response to the detection of a positive particle upstream of the sorting-junction.

37. The system according to claim 32, comprising means for reducing the flow rate of particles in the sample feeding conduit temporarily for 1 second or less after the detection of a positive particle upstream of the sorting-junction.

38. The system according to claim 32, wherein both the push-fluid and the spacer-fluid are aqueous fluids.

39. The system according to claim 32, comprising means for applying a variable, negative pressure to the sorted positive particle conduit [4] and the waste conduit [5].

40. The system according to claim 32, wherein the cartridge comprises two or more sorting lanes, and wherein the two or more sorting lanes are organized in pairs.

41. The system according to claim 40, wherein the at least one detection zone comprises parts of at least two separate particle feeding conduits of a sorting lane pair.

42. The system according to claim 40, wherein each pair of sorting lanes comprises an upstream detection zone [12] and a downstream detection zone [13].

43. The system according to claim 40, wherein the instrument, at the upstream detection zone, detects signals from two separate droplet samples feeding conduits of a sorting lane pair, and wherein each of the two sample feeding conduits comprise a detection loop, and wherein the two detection loops are of different lengths.

44. The system according to claim 32, wherein the downstream detection zone is designed to allow the instrument to detect whether a correct sorting has occurred.

45. The system according to claim 40, wherein the two or more sorting lanes are pneumatically connected to the same pressure supply.

46. The system according to claim 32, wherein the instrument, in addition to being designed to fit the cartridge, control and drive the fluids through the cartridge is also designed to fit, control and drive the fluids through a cartridge made to produce single emulsion droplets as well as a cartridge made to produce double emulsion droplets.

47. A cartridge comprising at least one microfluidic sorting-unit as defined in claim 32, wherein the unit comprises (i) at least one sample feeding conduit for feeding a sample fluid to a sorting-junction wherein the sample fluid comprises a mixture of positive and negative particles to be sorted [1], (ii) at least one microfluidic sorted positive particles conduit for removing a fluid comprising positive particles from the sorting-junction [4], (iii) at least one microfluidic waste conduit for removing a waste fluid comprising negative particles from the sorting-junction [5], and (iv) at least one push-fluid conduit [3] for feeding push-fluid to the sorting-junction, said sorting-unit is characterized in that at least four microfluidic conduits (i), (ii), (iii) and (iv) meet at the sorting-junction [2]
said cartridge further comprising at least one detection zone for detecting a positive particle in the sample feeding conduit (i) upstream the sorting-junction, wherein the particles are double-emulsion droplets.

48. The system according to claim 32 wherein the instrument comprises an optical head which forms an integrated unit comprising an optical system that forms 2 linear detection zones, the upstream and the downstream detection zones, said optical head further comprising the optics and the detectors needed for detection of positive particles.

49. The system according to claim 48, wherein the instrument is adapted for detecting positive particles by a laser-induced fluorescent signal.

50. The system according to claim 49, wherein the instrument is adapted for collecting the fluorescent signal emitted from positive particles both in the upstream and the downstream detection zones through one single lens-system.

51. The system according to claim 48, wherein the instrument comprises an automatic alignment system which align the cartridge with the optical system, the alignment system comprises 3 actuators which align the optical system and the cartridge by moving the optical head in the X-Y plane.

52. The system according to claim 32, wherein the instrument controls the flow of fluids through the at least one microfluidic sorting-unit by a pneumatic system which operates with both variable, positive and with variable, negative pressures.

53. The system according to claim 52, wherein the pneumatic system comprises a set of directional control valves which are able to feed the microfluidic system with high positive pressure or low positive pressure, and a different set of directional control valves which are able to feed the microfluidic system with variable negative pressure or ambient pressure.

54. A method for sorting of particles using the system according to claim 32, wherein the particles are double-emulsion droplets, comprising the steps of:
i. providing a sample fluid comprising particles,
ii. providing a microfluidic cartridge comprising at least one microfluidic sorting-unit wherein the unit comprises (a) at least one sample feeding conduit for feeding a sample fluid to a sorting-junction wherein the sample fluid comprises a mixture of positive and negative particles to be sorted [1], (b) at least one microfluidic sorted positive particles conduit for removing a fluid comprising positive particles from the sorting-junction [4], (c) at least one microfluidic waste conduit for removing a waste fluid comprising negative particles from the sorting-junction [5], and (d) at least one push-fluid conduit [3] for feeding push-fluid to the sorting-junction, said sorting-unit is characterized in that at least four microfluidic conduits (a), (b), (c) and (d) meet at the sorting-junction [2]; said cartridge further comprises at least one detection zone for detecting a positive particle in the sample feeding conduit (i) upstream the sorting-junction, a supply well or container comprising a volume of push-fluid, a supply well or container comprising a volume of spacer-fluid and a supply well or container comprising a volume of the particle sample fluid,
iii. inserting the cartridge into the instrument,
iv. starting the sorting on the system, and
v. after the sorting is complete, transferring the sorted positive particles into a suitable container;
wherein the flow rate of particles is temporarily decreased in response to a positive signal detected by the instrument at the upstream detection zone [12] of the cartridge.

55. An in-vitro method for enriching one or more target nucleic acid molecules from a sample of mixed nucleic acid molecules comprising the steps of:
i. providing a liquid sample of mixed nucleic molecules comprising at least one or more specific target nucleic acid molecule and at least one reagent for a specific detection of at least one of said target nucleic acid molecules,
ii. forming an emulsion comprising a plurality of double-emulsion liquid droplets each comprising mixed nucleic acid molecules from said liquid sample,
iii. incubating the emulsion liquid droplets to obtain a specific detectable reaction in droplets containing at least one specific target nucleic acid molecule,
iv. loading the reacted droplets into the system for sorting droplets according to claim 32,
v. sorting the microdroplets by use of the system,
vi. collecting the sorted droplets in a suitable container, coalescing the sorted droplets, and
vii. subjecting the coalesced selected droplets from step vi to a general amplification procedure.

56. A kit of parts comprising:
a) at least one cartridge comprising at least one microfluidic sorting-unit, wherein the unit comprises (i) at least one sample feeding conduit for feeding a sample fluid to a sorting-junction wherein the sample fluid comprises a mixture of positive and negative particles to be sorted [1], (ii) at least one microfluidic sorted positive particles conduit for removing a fluid comprising positive particles from the sorting-junction [4], (iii) at least one microfluidic waste conduit for removing a waste fluid comprising negative particles from the sorting-junction [5], and (iv) at least one push-fluid conduit [3] for feeding push-fluid to the sorting-junction, said sorting-unit is characterized in that at least four microfluidic conduits (i), (ii), (iii) and (iv) meet at the sorting-junction [2]; wherein said cartridge further comprises at least one detection zone for detecting a positive particle in the sample feeding conduit (i) upstream the sorting-junction,
b) at least one gasket to fit the at least one cartridge to an instrument of a system for sorting of particles, wherein the particles are double-emulsion droplets, and
c) at least one vial of buffer fluid in an amount sufficient to perform the number of sortings provided for by the at least one cartridge.

57. The kit according to claim 56, wherein said at least one gasket fits the at least one cartridge to an instrument which controls the flow of fluids through the at least one microfluidic sorting-unit and which temporarily reduces the flow rate of particles in the sample feeding conduit in response to detecting a positive particle in the feeding conduit upstream of the sorting-junction,
